(19) United States
(12) Patent Application Publication
(10) Pub. No.: US 2026/0349639 A1
(43) Pub. Date: Nov. 5, 2026

(54) ELECTRONIC DEVICE, METHOD, AND NON-TRANSITORY COMPUTER READABLE STORAGE MEDIUM FOR DISPLAYING WINDOW INCLUDING EXECUTION SCREEN

(71) Applicant: SAMSUNG ELECTRONICS CO., LTD., Suwon-si (KR)

(72) Inventors: Huijeong LEE, Suwon-si (KR); Daesik HWANG, Suwon-si (KR); Choonhee SHIM, Suwon-si (KR); Jooyong KIM, Suwon-si (KR); Jeongseob KIM, Suwon-si (KR); Yeojin KIM, Suwon-si (KR); Sangheon KIM, Suwon-si (KR)

(73) Assignee: SAMSUNG ELECTRONICS CO., LTD., Suwon-si (KR)

(21) Appl. No.: 19/529,771

(22) Filed: Feb. 4, 2026

Related U.S. Application Data
(63) Continuation of application No. PCT/KR2026/001291, filed on Jan. 21, 2026.

(30) Foreign Application Priority Data
Apr. 30, 2025 (KR) 10-2025-0057846
Jun. 10, 2025 (KR) 10-2025-0075947

(51) Int. Cl. G06F 3/14

(52) U.S. Cl. CPC G06F 3/1431

(57) ABSTRACT

An electronic device includes: a display; communication circuitry; a processor including processing circuitry; and memory including one or more storage media storing instructions that, when executed by the processor, cause the electronic device to: generate a first workspace and a second workspace each configured to display an execution screen in a window having window control buttons, display, via the display, the first workspace, identify an external display device connected to the electronic device, via the communication circuitry, based on identifying the external display device being connected to the electronic device while the first workspace is displayed, identify the second workspace not displayed via the display as a workspace to be provided in the external display device, transmit, to the external display device, via the communication circuitry, data for displaying the second workspace in the external display device.

### CROSS-REFERENCE TO RELATED APPLICATIONS

This application is a by-pass continuation application of International Application No. PCT/KR2026/001291, filed on Jan. 21, 2026, which is based on and claims priority to Korean Patent Application No. 10-2025-0057846, filed on Apr. 30, 2025, and Korean Patent Application No. 10-2025-0075947, filed on Jun. 10, 2025, in the Ministry of Intellectual Property, the disclosures of which are incorporated by reference herein their entireties.

### BACKGROUND

### 1. Field

The present disclosure relates to an electronic device, a method, and a non-transitory computer-readable storage medium for displaying a window including an execution screen.

### 2. Description of Related Art

An electronic device may include communication circuitry. The electronic device may be connected to an external electronic device and may transmit data to the external electronic device, for example, by a wire or wirelessly, via the communication circuitry.

The above-described information may be provided as related art for the purpose of helping understanding of the present disclosure. No argument or decision is made as to whether any of the above description may be applied as prior art related to the present disclosure.

### SUMMARY

According to an aspect of the disclosure, an electronic device is provided. The electronic device may comprise a display. The electronic device may comprise communication circuitry. The electronic device may comprise memory comprising one or more storage media storing instructions. The electronic device may comprise at least one processor comprising processing circuitry. The instructions, when executed by the at least one processor individually or collectively, may cause the electronic device to generate a first workspace and a second workspace each configured to display an execution screen in a window having window control buttons. The instructions, when executed by the at least one processor individually or collectively, may cause the electronic device to display, via the display, the first workspace from among the first workspace and the second workspace. The instructions, when executed by the at least one processor individually or collectively, may cause the electronic device to identify an external display device connected to the electronic device, via the communication circuitry. The instructions, when executed by the at least one processor individually or collectively, may cause the electronic device to, based on identifying the external display device being connected to the electronic device while the first workspace is displayed, identify the second workspace not displayed via the display as a workspace to be provided in the external display device. The instructions, when executed by the at least one processor individually or collectively, may cause the electronic device to transmit data for displaying the second workspace in the external display device, to the external display device, via the communication circuitry. The instructions, when executed by the at least one processor individually or collectively, may cause the electronic device to, based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace. The instructions, when executed by the at least one processor individually or collectively, may cause the electronic device to, while the execution history screen is displayed via the display, identify a second user input for the at least a portion of the second UI object corresponding to the second workspace. The instructions, when executed by the at least one processor individually or collectively, may cause the electronic device to, based on the second user input, change a workspace to be provided in the external display device from the second workspace to the first workspace. The instructions, when executed by the at least one processor individually or collectively, may cause the electronic device to, based on the second user input, transmit data for displaying the first workspace in the external display device, to the external display device, via the communication circuitry. The instructions, when executed by the at least one processor individually or collectively, may cause the electronic device to, based on the second user input, display, via the display, the second workspace.

According to an aspect of the disclosure, an electronic device is provided. The electronic device may comprise a display. The electronic device may comprise communication circuitry. The electronic device may comprise memory comprising one or more storage media storing instructions. The electronic device may comprise at least one processor comprising processing circuitry. The instructions, when executed by the at least one processor individually or collectively, may cause the electronic device to generate a first workspace and a second workspace each configured to display an execution screen in a window having window control buttons. The instructions, when executed by the at least one processor individually or collectively, may cause the electronic device to display, via the display, the first workspace from among the first workspace and the second workspace. The instructions, when executed by the at least one processor individually or collectively, may cause the electronic device to identify an external display device connected to the electronic device, via the communication circuitry. The instructions, when executed by the at least one processor individually or collectively, may cause the electronic device to, based on identifying the external display device being connected to the electronic device while the first workspace is displayed, identify the second workspace not displayed via the display as a workspace to be provided in the external display device. The instructions, when executed by the at least one processor individually or collectively, may cause the electronic device to transmit data for displaying the second workspace in the external display device, to the external display device, via the communication circuitry. The instructions, when executed by the at least one processor individually or collectively, may cause the electronic device to, while the first workspace is displayed via the display of the electronic device and the second workspace is displayed in the external display device, allow moving a pointer between the first workspace and the second workspace. The instructions, when executed by the at least one processor individually or collectively, may cause the electronic device to, while the first workspace is displayed via the display of the electronic device and the second workspace is displayed in the external display device, disallow moving a window movable in the first workspace into the second workspace. The instructions, when executed by the at least one processor individually or collectively, may cause the electronic device to, while the first workspace is displayed via the display of the electronic device and the second workspace is displayed in the external display device, disallow moving a window movable in the second workspace into the first workspace.

According to an aspect of the disclosure, an electronic device is provided. The electronic device may comprise a display. The electronic device may comprise communication circuitry. The electronic device may comprise memory comprising one or more storage media storing instructions. The electronic device may comprise at least one processor comprising processing circuitry. The instructions, when executed by the at least one processor individually or collectively, cause the electronic device to display, via the display, a first workspace configured to display an execution screen in a window having window control buttons. The instructions, when executed by the at least one processor individually or collectively, cause the electronic device to, while displaying the first workspace, identify an external display device connected to the electronic device, via the communication circuitry. The instructions, when executed by the at least one processor individually or collectively, cause the electronic device to, based on identifying the external display device, generate a second workspace configured to display an execution screen in a window having window control buttons. The instructions, when executed by the at least one processor individually or collectively, cause the electronic device to transmit data for displaying the second workspace in the external display device, to the external display device, via the communication circuitry. The instructions, when executed by the at least one processor individually or collectively, cause the electronic device to, based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace. The instructions, when executed by the at least one processor individually or collectively, cause the electronic device to, while the execution history screen is displayed via the display, identify a second user input for the at least a portion of the second UI object corresponding to the second workspace. The instructions, when executed by the at least one processor individually or collectively, cause the electronic device to, based on the second user input, change a workspace to be provided in the external display device from the second workspace to the first workspace. The instructions, when executed by the at least one processor individually or collectively, cause the electronic device to, based on the second user input, transmit data for displaying the first workspace in the external display device, to the external display device, via the communication circuitry. The instructions, when executed by the at least one processor individually or collectively, cause the electronic device to, based on the second user input, display, via the display, the second workspace.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an electronic device and an external display device connected to the electronic device;

FIGS. 2A and 2B illustrate examples of a simplified block diagram of an electronic device;

FIG. 3A illustrates an example of an electronic device displaying a workspace and an external display device displaying a workspace;

FIG. 3B illustrates an example of a workspace displayed via a display;

FIG. 3C illustrates an example of operations of an electronic device that displays a first workspace and provides a second workspace to an external display device;

FIG. 4 illustrates an example of operations of an electronic device for adaptively displaying an execution history screen according to a user input;

FIG. 5A illustrates an example of a workspace displayed in an external display device according to a connection between an electronic device and the external display device;

FIG. 5B illustrates an example of operations of an electronic device displaying a workspace via an external display device;

FIG. 6A illustrates an example of an electronic device displaying an execution history screen;

FIG. 6B illustrates an example of operations of an electronic device for displaying an execution history screen;

FIGS. 7A and 7B illustrate examples of a visual object and/or a UI object included in an execution history screen;

FIG. 8A illustrates an example of an electronic device displaying a visual object for generating a workspace;

FIG. 8B illustrates an example of operations of an electronic device for displaying a visual object for generating a workspace;

FIG. 9A illustrates an example of an electronic device generating a workspace;

FIG. 9B illustrates an example of operations of an electronic device for displaying a generated workspace;

FIG. 10 illustrates an example of an external display device displaying a generated workspace.

FIG. 11 illustrates an example of an execution history screen including a visual object for generating a workspace;

FIGS. 12A and 12B illustrate examples of an electronic device that transmits data for a workspace to an external display device;

FIG. 13 illustrates an example of an electronic device that stores information for an external display device and information for a workspace displayed in the external display device;

FIGS. 14A, 14B, and 14C illustrate examples of an electronic device that receives a user input for a UI object corresponding to a workspace being displayed in an external display device;

FIG. 15 illustrates an example of operations of changing a workspace displayed via a display of an electronic device;

FIG. 16 illustrates an example of an execution history screen; and

FIG. 17 is a block diagram of an electronic device in a network environment according to various embodiments.

The same reference numerals refer to the same parts, components, and structures throughout the drawings.

### DETAILED DESCRIPTION

Terms used in the present disclosure are used only to describe a specific embodiment, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

A term referring to data (e.g., data, information), a term referring to a value, a term for an computation state (e.g., operation, process), a term referring to an object (e.g., visual object, icon, button, application object, user interface (UI) object), a term referring to a network entities, and a term referring to a component of a device, and the like, that are used in the following description, are exemplified for convenience of explanation. In addition, a term such as ‘ . . . unit’, ‘ . . . device’, ‘ . . . object’, and ‘ . . . structure’, and the like used below may mean at least one shape structure or may mean a unit processing a function.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

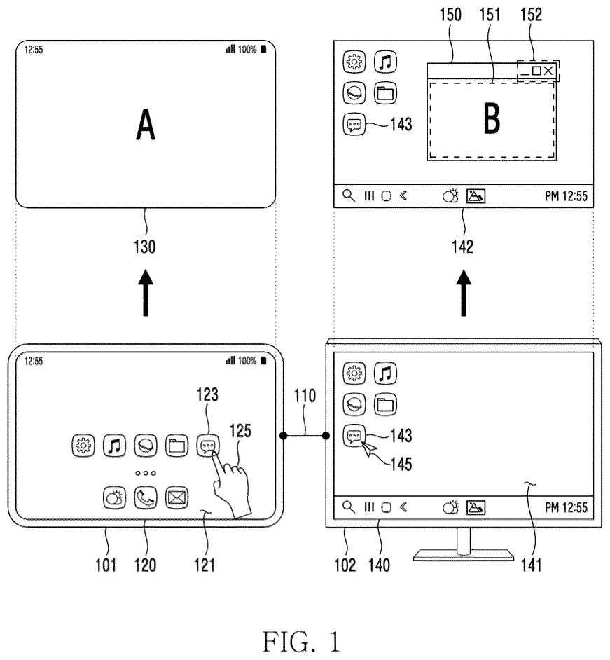

FIG. 1 illustrates an example of an electronic device and an external display device connected to the electronic device. An electronic device 101 may be one of various types of mobile devices, such as smartphones having various form factors (e.g., a bar-type smartphone, a foldable smartphone, or a rollable-type smartphone), a tablet, a cellular phone, and other similar computing devices. The electronic device 101 may be referred to as a user device, a multifunctional device, or a portable device.

Referring to FIG. 1, the electronic device 101 may include a display 120. The electronic device 101 may display a screen 121 via the display 120. The screen 121 may be referred to as a home screen. For example, the home screen may be referred to as a basic screen displayed by the electronic device 101 via the display 120. For example, the home screen may be referred to as a basic user interface (UI) displayed by the electronic device 101 via the display 120. For example, in order to display the home screen, a launcher application may be executed in the electronic device 101. For example, the screen 121 may include a widget. For example, the screen 121 may include a plurality of application objects. For example, the plurality of application objects may be disposed in a central region of the screen 121. As a non-limiting example, a disposition of the plurality of application objects may be determined by a user. For example, the screen 121 may include an application object 123.

The electronic device 101 may receive a user input for the application object 123. For example, the user input may include a touch input 125, but an embodiment is not limited thereto. The electronic device 101 may execute an application (e.g., an A application) indicated by the application object 123 according to the user input. For example, the electronic device 101 may display an execution screen 130 of the application via a display 120 according to execution of the application. For example, the execution screen 130 may be displayed in full screen. As a non-limiting example, according to an additional user input for the execution screen 130, the execution screen 130 may be displayed in at least a portion of a display region of the display 120. For example, the electronic device 101 may display the execution screen 130 by using the entire display region of the display 120 according to a first display mode from among the first display mode and a second display mode.

The electronic device 101 may display the execution screen 130 via the display 120 according to the first display mode from among the first display mode and the second display mode. For example, the first display mode may be referred to as a mobile mode, a tablet mode, and/or an equivalent technical term thereto. For example, the first display mode may be distinguished from the second display mode to be described later, but a standard for distinguishing between the first display mode and the second display mode may be different from a standard for distinguishing between a portrait mode of the electronic device and a landscape mode of the electronic device.

In the present disclosure, the first display mode may be referred to as a mode for displaying, according to execution of an application (e.g., the A application), an execution screen (e.g., the execution screen 130) of the application basically in full screen. The first display mode may be associated with a basic UI setting of a mobile device (e.g., a smartphone or a tablet). For example, the basic UI setting of the mobile device may be referred to as a UI setting designed or configured for a display region of a relatively small display (e.g., the display 120) of the mobile device. For example, the basic UI setting of the mobile device may be referred to as a UI setting designed or configured for a user experience of controlling the electronic device 101 through a touch input and/or an input using a stylus pen. For example, the first display mode may be implemented to improve a user experience in an environment where the touch input and/or the input using the stylus pen are mainly received rather than an input from a peripheral input device (e.g., a mouse and a keyboard).

The electronic device 101 may establish a connection 110 with an external display device 102. For example, the connection 110 may include a wireless connection and/or a wired connection. The electronic device 101 may transmit or provide data to the external display device 102 via the connection 110. For example, the electronic device 101 may transmit data for displaying a screen 141 in a display 140 of the external display device 102, to the external display device 102, via the connection 110.

For example, the data may include an image frame or a video frame. For example, rendering on the screen 141 may be performed in the electronic device 101. For example, the external display device 102 may be used to output the screen 141 rendered by the electronic device 101 and may not perform an operation associated with the rendering of the screen 141. In an embodiment, the external display device 102 may function as a simple manual output device.

The screen 141 may correspond to the screen 121. For example, the screen 141 may be referred to as a screen reconstructed or edited from the screen 121. For example, the screen 121 may be based on the first display mode, and the screen 141 may be based on the second display mode to be described later. The screen 141 may be substantially similar to a background screen of a desktop computer (e.g., a personal computer). The screen 141 may be configured to provide a user experience substantially similar to the desktop computer. For example, in the screen 141, application objects may be arranged from an upper left region of the screen 141. For example, the screen 141 may include a status bar in a lower region of the screen 141. The screen 141 may include a plurality of application objects. For example, the screen 141 may include an application object 143.

Data for displaying the screen 141 in the display 140 of the external display device 102 may include an image frame (or a video frame). For example, rendering on the screen 141 may be performed in the electronic device 101. For example, the external display device 102 may be used to output the screen 141 rendered by the electronic device 101 and may not perform an operation associated with the rendering of the screen 141. In an embodiment, the external display device 102 may function as a simple manual output device. For example, the electronic device 101 may identify or receive a user input for the application object 143 included in the screen 141. For example, the user input may include an input using a pointer 145, but the embodiment is not limited thereto. For example, the electronic device 101 may provide data for displaying a screen 142 in the display 140 to the external display device 102, based on identifying the user input for the application object 143.

The screen 142 may include a window 150 according to execution of an application (e.g., a B application) indicated by the application object 143. For example, the window 150 may include both an execution screen 151 and window control buttons 152 of the application. For example, the window control buttons 152 may be associated with a function of changing a size of the window 150 and/or a function of terminating the window 150. For example, the screen 142 may indicate a screen on which the window 150 is overlapped with and displayed on the screen 141. For example, the screen 142 may be displayed via the display 140 according to the second display mode from among the first display mode and the second display mode. For example, the second display mode may be referred to as a desktop mode, a multi-window mode, a Dex mode, and/or an equivalent technical term thereto. The Dex mode is a feature on phones and tablets that provides a desktop-like experience on an external monitor, transforming phones and tablets into portable computers for enhanced productivity with a familiar Windows-style interface.

In the present disclosure, the second display mode may be referred to as a mode for displaying the window 150 including both the execution screen 151 and the window control buttons 152 of the application according to the execution of the application (e.g., the B application). For example, the second display mode may be referred to as a mode for providing a desktop computer-style UI. For example, the second display mode may be provided for a user experience similar to a user experience using a desktop computer. For example, the UI according to the second display mode may be referred to as a UI designed or configured for a user experience of controlling the electronic device 101 through a keyboard input and/or a mouse input. For example, the second display mode may provide a UI for multi-tasking of the application and/or a UI for a multi-window function. For example, in the screen 142 based on the second display mode, a different window may be displayed together with the window 150 according to execution of another application. The screen 142 based on the second display mode may provide an environment where multiple tasks are possible for the user. For example, the screen 142 displayed according to the second display mode may be referred to as a workspace. For example, the workspace may be referred to as a desktop, a virtual desktop, and/or an equivalent technical term thereto.

The workspace may be referred to as a screen representing an independent work environment. For example, the workspace may be referred to as an independent UI environment. Each workspace may be configured to include a window of an application. Each workspace may be logically divided. For example, each workspace may be configured to operate in parallel with another workspace. For example, each workspace may be referred to as a logically separated display context in one system. For example, a memory resource may be independently allocated to each workspace. For example, a window (or an execution screen) of the application may be separately managed for each workspace. For example, a window movable in a first workspace may be disallowed to move to a second workspace different from the first workspace. For example, each workspace may be referred to as a UI operating in parallel with the other workspace. For example, each workspace may be logically separated from the other workspace. For example, each workspace may be referred to as a logically separated display context in one system. For example, data loaded into memory (e.g., a volatile memory) according to each workspace may not be shared with the other workspace. For example, a memory resource may be independently allocated to each workspace. For example, disposition information of a window included in each workspace may not be shared. The disposition information of the window may include a position of the window, a size of the window, and/or an overlapping state between the windows. For example, an input for each workspace may not be shared with the other workspace. For example, each workspace may be managed by a system as a separate activity stack and a separate task.

According to an embodiment, since the workspace is logically divided, density (or congestion) associated with the UI may be relatively reduced. For example, a window (or an execution screen) of the application may be separately managed for each workspace. For example, the window of the application displayed in each workspace may be determined or configured by the user. For example, by determining the window of the application displayed in each workspace by the user, productivity with respect to the user's work may be improved.

According to an embodiment, the electronic device 101 may execute an external output application (e.g., a Dex application) to output the screen 141 or 142 via the display 140 of the external display device 102. For example, the external output application may be different from the launcher application of the electronic device 101. For example, since the external output application and the launcher application are different, while the screen 141 or 142 according to the second display mode is displayed via the display 140 by the electronic device 101, the electronic device 101 may display the screen 121 or 130 according to the first display mode via the display 120. For example, the electronic device 101 may be restricted from displaying the screen according to the second display mode via the display 120. For example, the electronic device 101 may not display a workspace via the display 120. For example, while the screen 141 or 142 according to the second display mode is displayed via the display 140, the electronic device 101 may be restricted from performing an independent task. For example, the electronic device 101 may not support a linkage operation between the electronic device 101 and the external display device 102 while the screen 141 or 142 according to the second display mode is displayed via the display 140. For example, using the display 120 of the electronic device 101 as an auxiliary screen of the external display device 102 may be restricted. For example, the user's multi-screen experience may be degraded.

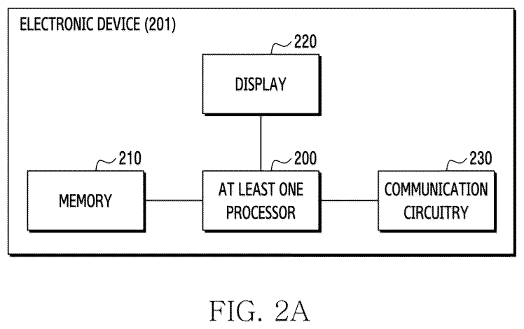

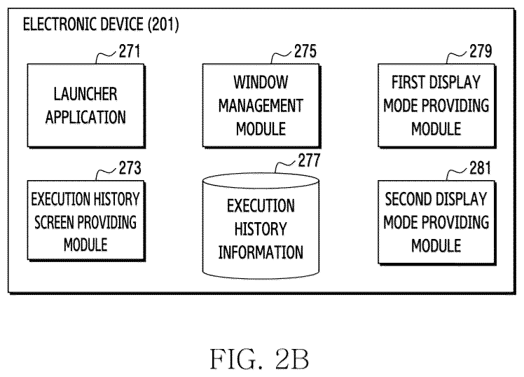

In the present disclosure, while the screen 141 or 142 according to the second display mode is displayed via the display 140 of the external display device 102 by the electronic device, a technology for displaying the screen according to the second display mode via the display of the electronic device is described. For example, the electronic device may display the second workspace via the display of the electronic device while the first workspace is displayed in the display 140. For example, the electronic device may include the launcher application including a function of the existing external output application. For example, by using the launcher application, the electronic device may provide data for displaying the first workspace to the external display device 102 and display the second workspace via the display. As a workspace is displayed in the display of the electronic device and the display 140 of the external display device 102 respectively, a multi-screen environment may be provided to the user of the electronic device. By providing the multi-screen environment to the user of the electronic device, work productivity of the user of the electronic device may be increased. A user experience of the electronic device may be enhanced. A method of displaying the workspace in the display of the electronic device and the display 140 of the external display device 102, respectively, may be executed in the electronic device. For example, the electronic device may include components (or hardware components) to provide the method of displaying the workspace in the display of the electronic device and the display 140 of the external display device 102, respectively. The components will be described and exemplified in more detail with reference to FIG. 2A.

FIGS. 2A and 2B illustrate examples of a simplified block diagram of an electronic device. The electronic device 201 may be an example of the electronic device 101 of FIG. 1.

Referring to FIG. 2A, the electronic device 201 may include at least one processor 200, memory 210, a display 220, and/or communication circuitry 230. For example, the at least one processor 200, the memory 210, the display 220, and/or the communication circuitry 230 may be electronically and/or operably coupled with each other by a communication bus. In the following paragraphs, hardware components being coupled may mean that a direct connection or an indirect connection between the hardware components is established by at least a wire or wirelessly such that a second hardware component among the hardware components is controlled by a first hardware component. The hardware components illustrated in FIG. 2A have been illustrated based on different blocks, but the present disclosure is not limited thereto. For example, a portion (e.g., the at least one processor 200, the memory 210, and the communication circuitry 230) of the hardware components illustrated in FIG. 2A may be included in a single integrated circuit such as a system on chip (SoC) or a system in package (SIP). A type and/or number of the hardware components included in the electronic device 201 is not limited as illustrated in FIG. 2A. For example, the electronic device 101 may include only a portion of the hardware components illustrated in FIG. 2A.

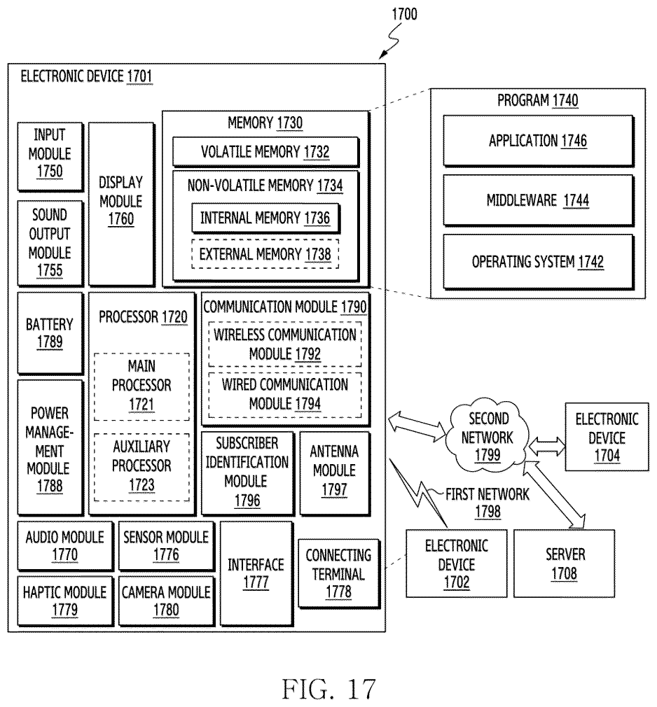

The at least one processor 200 may include a hardware component for processing data based on executing instructions. The at least one processor 200 may be configured to execute instructions stored in the memory 210 individually or collectively. The at least one processor 200 may include processing circuitry. For example, the hardware component for processing data may include an arithmetic and logic unit (ALU), a floating point unit (FPU), and a field programmable gate array (FPGA). For example, the hardware component for processing data may include a central processing unit (CPU), a graphic processing unit (GPU), a display processing unit (DPU), a neural processing unit (NPU), a digital signal processor (DSP), an application processor (AP), and/or a microcontroller (MCU). The at least one processor 200 may include one or more cores. For example, the at least one processor 200 may have a structure of a multi-core processor such as a dual core, a quad core, or a hexa core. The at least one processor 200 of FIG. 2A may be applied in substantially the same manner with respect to a processor 1720 of FIG. 17. The at least one processor 200 may be configured to control the memory 210, the display 220, and/or the communication circuitry 230.

The memory 210 may include a hardware component for storing data and/or instructions inputted to and/or outputted from the at least one processor 200. For example, the instructions may indicate a calculation and/or an operation performed by the at least one processor 200 of the electronic device 201 on data. The memory 210 may include one or more storage media. The memory 210 may include, for example, a volatile memory such as random-access memory (RAM) and/or a non-volatile memory such as a read-only memory (ROM). The volatile memory may include, for example, at least one of a dynamic RAM (DRAM), a static RAM (SRAM), a cache RAM, or a pseudo SRAM (PSRAM). The non-volatile memory may include, for example, at least one of a programmable ROM (PROM), an erasable PROM (EPROM), an electrically erasable PROM (EEPROM), a flash memory, a hard disk, a compact disk, or an embedded multimedia card (EMMC). A specific content for the memory 210 of FIG. 2A may be substantially equally applied to a content for memory 1730 of FIG. 17.

In an embodiment, in the memory 210 of the electronic device 201, one or more instructions (or commands) indicating a calculation and/or an operation performed by the at least one processor 200 of the electronic device 201 on data may be stored. A set of the one or more instructions may be referred to as a program, firmware, an operating system, a process, a routine, a sub-routine and/or an application.

The display 220 may include a hardware component of the electronic device 201 used to display a screen. For example, the display 220 may include light emitting elements, and circuits (e.g., transistors) that control the light emitting elements to emit light. For example, each of the light emitting elements may include an organic light emitting diode (OLED) or a micro LED. However, it is not limited thereto. For example, the display 220 may include a liquid crystal display (LCD).

The display 220 according to an embodiment may include a sensor (e.g., a touch sensor panel (TSP)) for detecting an external object (e.g., a finger of a user) on the display 220. For example, based on the TSP, the electronic device 201 may detect the external object contacting the display 220 or floating on the display 220. In response to or based on detecting the external object, the electronic device 201 may execute a function associated with a specific visual object displayed at a position on the display 220 to which the external object is contacted from among visual objects displayed on the display 220. Throughout the present disclosure, ‘in response to’ may be replaced with ‘based on’.

The communication circuitry 230 may include a hardware component configured to support transmission and/or reception of signals between the electronic device 201 and an external electronic device (e.g., an external display device 102). As one non-limiting example, the communication circuitry 230 may be used to establish a wired connection between the electronic device 201 and the external electronic device. As another non-limiting example, the communication circuitry 230 may be used to establish a wireless connection between the electronic device 201 and the external electronic device. For example, the communication circuitry 230 may include first communication circuitry configured to support wireless communication and/or second communication circuitry configured to support wired communication.

The communication circuitry 230 may include, for example, at least one of a modem, an antenna, or an optic/electronic (O/E) converter. The communication circuitry 230 may support transmission and/or reception of electrical signals based on various types of protocols such as Ethernet, a local area network (LAN), a wide area network (WAN), wireless fidelity (WiFi), Bluetooth™, Bluetooth low energy (BLE), Zigbee, long term evolution (LTE), and 5G new radio (NR).

The communication circuitry 230 may support one or more designated protocols that may be used for the electronic device 201 to be directly connected to the external electronic device in a wire. For example, the communication circuitry 230 may include a high definition multimedia interface (HDMI) and/or a universal serial bus (USB) interface.

A specific content for the communication circuitry 230 of FIG. 2A may be substantially equally applied to an interface 1777, a communication module 1790, and/or an antenna module 1797 of FIG. 17.

The electronic device 201 exemplified in a description of FIG. 2A may execute at least a portion of operations exemplified in a description of FIGS. 2B to 16. For example, the operations exemplified in the description of FIGS. 2B to 16 may be performed, controlled, executed, or caused by (or in) the electronic device 201 according to a control of the at least one processor 200.

Referring to FIG. 2B, the electronic device 201 may include a launcher application 271, an execution history screen providing module 273, a window management module 275, execution history information 277, a first display mode providing module 279, and/or a second display mode providing module 281.

The launcher application 271 may be referred to as an application used to configure, generated, or manage a home screen of the electronic device 201. For example, the home screen may be referred to as a default screen of the electronic device 201. The launcher application 271 may be referred to as a program or UI module for managing or executing an application, a function, and/or a service. For example, the launcher application 271 may be referred to as a home application, a default UI application, an application launcher, a UI launcher, and/or an equivalent technical term thereto. For example, descriptions of the launcher application of FIG. 1 may be referenced for the launcher application 271.

The launcher application 271 may be used to display a screen indicating a list of application(s) in the electronic device 201 via a display (e.g., the display 220). For example, the screen indicating the list of the application may include a home screen and/or an app drawer screen. For example, the screen indicating the list of the application may include an application object corresponding to the application. For example, according to a user input for the application object, the electronic device 201 may execute an application corresponding to the application object using the launcher application 271.

The launcher application 271 may provide a request to the execution history screen providing module 273 based on the electronic device 201 identifying a user input for displaying an execution history screen. For example, the user input for displaying the execution history screen may include an input and/or a gesture input for a visual object for the execution history screen.

The execution history screen providing module 273 may be used to display the execution history screen. The electronic device 201 may display the execution history screen via the display by using the execution history screen providing module 273. For example, the execution history screen may be referred to as a screen indicating a list of applications that are executing in the electronic device 201 and/or applications that were executed on the electronic device 201. For example, the execution history screen may be referred to as a recent screen, a recent view, and/or an equivalent technical term thereto.

The execution history screen may display a visual object (e.g., an app card) corresponding to each of the applications. For example, each visual object may be arranged in an order in which a corresponding application is executed in the electronic device 201. In response to identifying a user input for a visual object included in the execution history screen, the electronic device 201 may display an execution screen of an application corresponding to the visual object via the display. As a non-limiting example, the electronic device 201 may change a display mode of the electronic device 201 from a second display mode to a first display mode according to the user input for the visual object (e.g., the app card) included in the execution history screen while providing the second display mode from among the first display mode and the second display mode.

The execution history screen may include a visual object (e.g., a workspace card, or a UI object) corresponding to a workspace. In response to identifying a user input for the visual object included in the execution history screen, the electronic device 201 may display a workspace corresponding to the visual object via the display. As a non-limiting example, the electronic device 201 may change the display mode of the electronic device 201 from the first display mode to the second display mode according to the user input for the visual object (e.g., the workspace card, or the UI object) included in the execution history screen while providing the first display mode.

The window management module 275 may be used to manage information of a window including the execution screen of the application. For example, the information of the window may include a position of the window, a size of the window, a shape of the window, and/or a generation time of the window. The information of the window may be added, removed, or updated according to a request and/or a policy of another module. The window management module 275 may provide information of a window corresponding to a request, to an external module according to the request of the external module. The window management module 275 may be referred to as a window manager.

The execution history information 277 may indicate information related to an execution history of an application executed in the electronic device 201. The execution history of the application may be stored in the execution history information 277 according to an execution order of the application. As for the execution history information 277, information may be added or information may be removed by the window management module 275. The execution history information 277 may be referred to as recent task information.

The first display mode providing module 279 may be used to provide the first display mode. For example, the electronic device 201 may display a screen according to the first display mode via the display (e.g., the display 220) by using the first display mode providing module 279. For the first display mode, descriptions of the first display mode of FIG. 1 may be referred to.

The second display mode providing module 281 may be used to provide the second display mode. For example, the electronic device 201 may display a screen according to the second display mode via the display (e.g., the display 220) by using the second display mode providing module 281. For example, the electronic device 201 may display a workspace via the display by using the second display mode providing module 281. For example, the electronic device 201 may provide data for displaying the screen according to the second display mode in the external display device (e.g., the external display device 102) to the external display device by using the second display mode providing module 281. For example, the electronic device 201 may provide data for displaying the workspace in the external display device to the external display device by using the second display mode providing module 281. For the second display mode, descriptions of the second display mode of FIG. 1 may be referred to.

As a non-limiting example, a module of the electronic device 201 is not limited to an embodiment, and at least one module may perform an operation by being integrated or further including an additional module, and at least one module may be implemented as hardware or software.

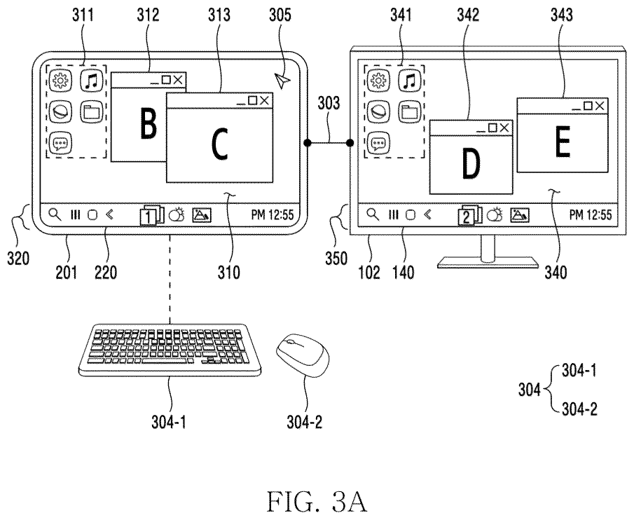

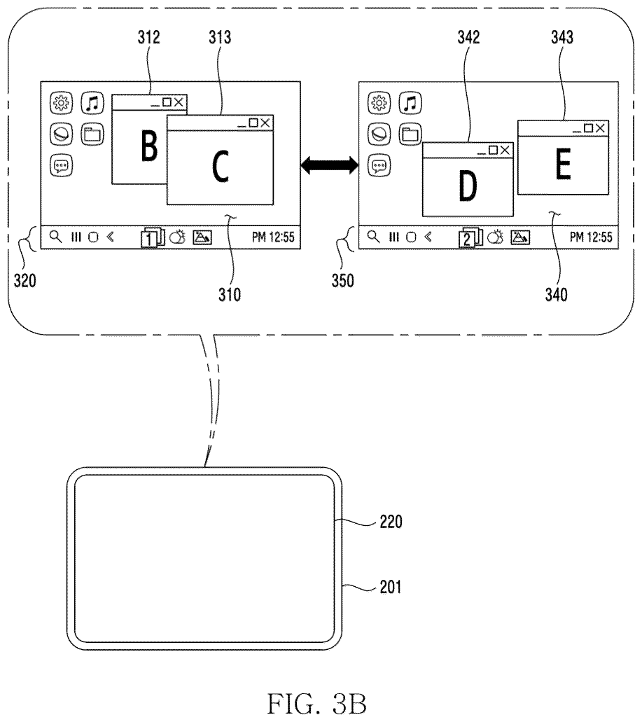

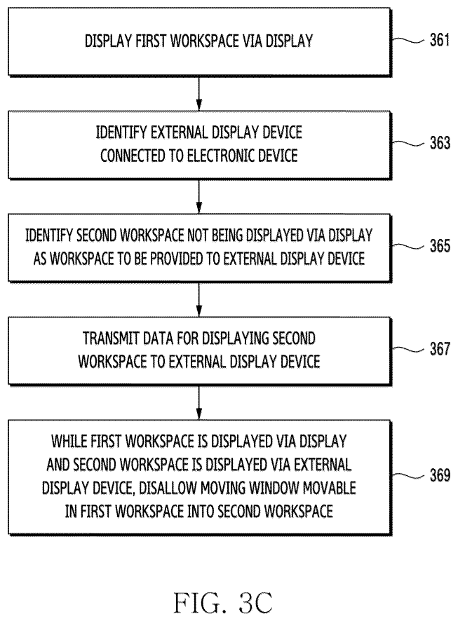

FIG. 3A illustrates an example of an electronic device displaying a workspace and an external display device displaying a workspace.

Referring to FIG. 3A, the electronic device 201 may display a workspace 310 via a display 220. For example, the electronic device 201 may display the workspace 310 via the display 220 according to a second display mode from among a first display mode and the second display mode. For each of the first display mode and the second display mode, descriptions of the first display mode and the second display mode of FIG. 1 may be referred to. The electronic device 201 may establish a connection 303 between the electronic device 201 and an external display device 102. For example, the connection 303 may include a wireless connection and/or a wired connection. For example, communication circuitry (e.g., communication circuitry 230) may be used for the connection 303. The electronic device 201 may transmit data to the external display device 102 using the communication circuitry via the connection 303. For example, the electronic device 201 may transmit or provide data for displaying a workspace 340 to the external display device 102 while displaying the workspace 310 via the display 220. For example, the data for displaying the workspace 340 may be referred to as data for the workspace 340 rendered according to the second display mode. For example, while the workspace 310 is displayed in the electronic device 201 (or the display 220), the workspace 340 may be displayed in the external display device 102 (or a display 140).

The electronic device 201 may be connected to an input device 304 via the communication circuitry (e.g., the communication circuitry 230). Although a connection between the electronic device 201 and the input device 304 is illustrated as a wireless connection in FIG. 3A, as a non-limiting example, the connection between the electronic device 201 and the input device 304 may include a wired connection. For example, the input device 304 may include a keyboard 304-1 and/or a mouse 304-2, but an embodiment is not limited thereto. For example, the electronic device 201 may identify a signal transmitted from the input device 304 as an input of the electronic device 201. For example, the electronic device 201 may display a pointer 305 corresponding to the input device 304 via the display 220. For example, the pointer 305 may indicate a position where a user input is provided. For example, the pointer 305 may move within the workspace 310 according to the signal transmitted from the input device 304. For example, the movement of the pointer 305 may correspond to a movement of the input device 304 (e.g., the mouse 304-2). As a non-limiting example, the movement of the pointer 305 may be controlled according to a touch input received via the display 220. For example, the position of the pointer 305 may correspond to a position of a contact point of the touch input identified via display 220. For example, the electronic device 201 may control elements included in the workspace 310 using the pointer 305.

According to an embodiment, the pointer 305 may move from the workspace 310 displayed via the display 220 of the electronic device 201 to the workspace 340 displayed via the display 140 of the external display device 102. As a non-limiting example, the pointer 305 may move from the workspace 340 to the workspace 310. For example, the pointer 305 positioned within the workspace 310 may move to a right periphery of the workspace 340. For example, as the pointer 305 moves to the right periphery of the workspace 310, it may be displayed in a left periphery of the workspace 340. For example, after the pointer 305 moves to the workspace 340, the pointer 305 may be used to control elements included in the workspace 340. For example, a multi-screen experience of a user of the electronic device 201 may be enhanced by being capable of moving between the workspaces 310 and 340 in which the pointer 305 is displayed.

The workspace 310 may display a plurality of application objects 311, a window 312, a window 313, and/or a taskbar 320. As a non-limiting example, the taskbar 320 may not be displayed in the workspace 310.

The window 312 may be displayed according to a user input for one of the plurality of application objects 311. The window 312 may include an execution screen of an application (e.g., a B application) and window control buttons (e.g., window control buttons 152). For example, the window control buttons may include a button for minimizing a size of the window 312, a button for maximizing the size of window 312, and/or an exit button of the window 312.

The window 313 may be displayed according to a user input for one of the plurality of application objects 311. The window 313 may include an execution screen of an application (e.g., a C application) and window control buttons. For example, the window control buttons may include a button for minimizing a size of the window 313, a button for maximizing the size of the window 313, and/or an exit button of the window 313.

According to an embodiment, each of the windows 312 and 313 may move within the workspace 310 according to a user input. For example, each of the windows 312 and 313 may move within the workspace 310 according to a drag and drop input.

According to an embodiment, it may be disallowed for the windows 312 and 313 to move from the workspace 310 to the workspace 340. For example, it may be disallowed for the windows 312 and 313 to move from the workspace 310 to the workspace 340 according to a drag and drop input. For example, the workspace 310 and the workspace 340 may be logically separated from each other. The windows 312 and 313 within the workspace 310 may be dependent on the workspace 310. For example, since the workspace 310 and the workspace 340 are logically separated, it may be restricted for the windows 312 and 313 to move from the workspace 310 to the workspace 340. For example, a region of memory (e.g., memory 210) allocated to render the workspace 310 and a region of the memory allocated to render the workspace 340 may be divided.

As a non-limiting example, an exchange of data indicating a content between the workspace 310 and the workspace 340 may be basically restricted. For example, data sharing between the workspace 310 and the workspace 340 may be restricted. For example, the data exchange between the workspace 310 and the workspace 340 being basically restricted in terms of how the workspace 310 and the workspace 340 are managed as a separate activity stack and a separate task by an operating system of the electronic device 201. For example, since the workspace 310 and the workspace 340 are managed as the separate activity stack and the separate task by the operating system of the electronic device 201, an exchange of data performed at a level higher than a layer level corresponding to the operating system of the electronic device 201 may be restricted. In other words, an exchange of data between the workspace 310 and the workspace 340 may be possible, in accordance with an exchange (or a change) of data performed at a level lower than or equal to the layer level corresponding to the operating system level of the electronic device 201.

As an embodiment, the electronic device 201 may identify an input for displaying a window 342 corresponding to an application (e.g., a D application) in the workspace 310 while displaying the workspace 310 via the display 220. For example, the electronic device 201 may change a workspace in which the window 342 is included from the workspace 340 to the workspace 310 based on the identification of the input. For example, changing the workspace including the window 342 from the workspace 340 to the workspace 310 may be performed at a level lower than or equal to the layer level corresponding to the operating system level. For example, the electronic device 201 may display the workspace 310 including the window 342 via the display 220.

The taskbar 320 may be positioned in a periphery of the workspace 310. The taskbar 320 may be displayed in a lower region of the workspace 310. For example, the taskbar 320 may include an icon for an application executed while the workspace 310 is displayed. For example, the taskbar 320 may display time information. For example, the taskbar 320 may include an icon for switching a display of the windows 312 and 313 displayed within the workspace 310.

The external display device 102 may display the workspace 340 via the display 140. Rendering on the workspace 340 may be performed in the electronic device 201. For example, the electronic device 201 may render the workspace 340 according to the second display mode from among the first display mode and the second display mode. For example, the electronic device 201 may transmit data for the rendered workspace 340 to the external display device 102 via the communication circuitry (e.g., the communication circuitry 230).

The workspace 340 may display a plurality of application objects 341, the window 342, a window 343, and/or a taskbar 350. As a non-limiting example, the taskbar 350 may not be displayed in the workspace 340.

The window 342 may be displayed according to a user input for one of the plurality of application objects 341. The window 342 may include an execution screen of the application (e.g., the D application) and window control buttons (e.g., the window control buttons 152). For example, the window control buttons may include a button for minimizing a size of the window 342, a button for maximizing the size of the window 342, and/or an exit button of the window 342.

The window 343 may be displayed according to a user input for one of the plurality of application objects 341. The window 343 may include an execution screen of an application (e.g., an E application) and window control buttons. For example, the window control buttons may include a button for minimizing a size of the window 343, a button for maximizing the size of the window 343, and/or an exit button of the window 343.

According to an embodiment, each of the windows 342 and 343 may move within the workspace 340 according to a user input. However, it may be disallowed for the windows 342 and 343 to move from the workspace 340 to the workspace 310.

Since the taskbar 350 may be substantially the same as the taskbar 320, a redundant description may be omitted.

In an embodiment, an exemplary first case in which the first workspace 310 is displayed in the display 220 of the electronic device 201 and the second workspace 340 is displayed in the display 140 of the external display device 102 may be distinguished from a second case in which a first screen corresponding to a first portion of one workspace is displayed in the display 220 of the electronic device 201 and a second screen corresponding to a second portion of the one workspace is displayed in the display 140 of the external display device 102. For example, a method for the windows 312 and 313 to move from the first workspace 310 to the second workspace 340 in the first case may be different from a method for a window in the first screen to move from the first screen to the second screen in the second case.

In an embodiment, an exemplary case in which the first workspace 310 is displayed in the display 220 of the electronic device 201 and the second workspace 340 is displayed in the display 140 of the external display device 102 may be distinguished from a multi-screen environment executed by one or more operating systems. For example, the exemplary case in which the first workspace 310 is displayed in the display 220 of the electronic device 201 and the second workspace 340 is displayed in the display 140 of the external display device 102 may be distinguished from a case in which the first screen is displayed in the display 220 of the electronic device 201 by a first operating system and the second screen is displayed in the display 140 of the external display device 102 by a second operating system.

In an embodiment, the exemplary case in which the first workspace 310 is displayed in the display 220 of the electronic device 201 and the second workspace 340 is displayed in the display 140 of the external display device 102 may be distinguished from a remote system execution function performed by the electronic device 201.

FIG. 3B illustrates an example of a workspace displayed via a display.

Referring to FIG. 3B, the electronic device 201 may generated a workspace 310 and a workspace 340. The electronic device 201 may render the workspace 310. The electronic device 201 may render the workspace 340. The electronic device 201 may display one of the workspace 310 and the workspace 340 via a display 220.

The workspace 310 and the workspace 340 may be referred to as screens respectively indicating independent work environments. For example, each of the workspace 310 and the workspace 340 may independently indicate UI. For example, the workspace 310 may be configured to display an execution screen (e.g., an execution screen of a B application, or an execution screen of a C application) within a window (e.g., a window 312, or a window 313) having window control buttons (e.g., window control buttons 152). For example, the workspace 340 may be configured to display an execution screen (e.g., an execution screen of a D application, or an execution screen of an E application) within a window (e.g., a window 342, or a window 343) having window control buttons. For example, the workspace 310 may display the windows 312 and 313, and the workspace 340 may display the windows 342 and 343. For example, the workspace 310 may be used to manage the windows 312 and 313, and the workspace 340 may be used to manage the windows 342 and 343. For example, an exchange of data indicating a content between the workspace 310 and the workspace 340 may be restricted. For example, data sharing between the workspace 310 and the workspace 340 may be restricted. For example, a user input for the workspace 310 may be independent of the workspace 340. For example, a user input for the workspace 340 may be independent of the workspace 310. For example, the workspace 310 and the workspace 340 may be managed as a separate activity stack and a separate task by a system of the electronic device 201. For example, a resource of memory (e.g., memory 210) used to render the windows 312 and 313 within the workspace 310 and a resource of the memory (e.g., the memory 210) used to render the windows 342 and 343 within the workspace 340 may be divided. For example, the resource of the memory being divided may include that a separate resource is allocated to each workspace as each workspace is managed as the separate activity stack and/or the separate task.

The electronic device 201 may determine a workspace to be displayed via the display 220 from among the workspaces 310 and 340 according to a user input. For example, the electronic device 201 may display the determined workspace via the display 220. For example, the electronic device 201 may determine a workspace to be displayed in an external display device (e.g., an external display device 102) from among the workspaces 310 and 340 according to a user input. For example, the electronic device 201 may provide data for displaying the determined workspace to the external display device via communication circuitry (e.g., communication circuitry 230).

FIG. 3C illustrates an example of operations of an electronic device that displays a first workspace and provides a second workspace to an external display device.

Referring to FIG. 3C, in operation 361, the electronic device 201 may display a first workspace via a display (e.g., a display 220). For example, the first workspace may be configured to display an execution screen in a window having window control buttons. The electronic device 201 may generate, obtain, render, provide, or activate the first workspace.

According to an embodiment, the electronic device 201 may generate the first workspace based on activation of a second display mode. For example, the second display mode may be referred to as a mode for displaying a window including both (or simultaneously) the execution screen of the application and window control buttons according to the execution of the application. For example, while the second display mode is activated, the electronic device 201 may display a window including the execution screen of the application according to the execution of the application. For example, the second display mode may be referred to as a mode that provides a workspace configured to display the execution screen in the window having the window control buttons. For the second display mode, descriptions of the second display mode of FIG. 1 may be referred to.

In response to the activation of the second display mode, the electronic device 201 may identify whether a pre-generated workspace remains. For example, the electronic device 201 may not generate the first workspace based on identifying that the pre-generated workspace remains. For example, the electronic device 201 may display the pre-generated workspace via the display 220 based on identifying that the pre-generated workspace remains. For example, the electronic device 201 may generate the first workspace based on identifying that the pre-generated workspace does not remain. However, an embodiment is not limited thereto.

According to an embodiment, the electronic device 201 may generate a second workspace according to a connection with an external display device (e.g., an external display device 102). The electronic device 201 may include the pre-generated first workspace. In an exemplary case in which the number of workspaces included in the electronic device 201 is one, the electronic device 201 may identify the external display device 102 via communication circuitry (e.g., communication circuitry 230). For example, the electronic device 201 may establish a connection with the external display device 102. In an exemplary case in which the number of workspaces included in the electronic device 201 is one, the electronic device 201 may generate the second workspace according to the connection with the external display device 102. However, the embodiment is not limited thereto.

According to an embodiment, the electronic device 201 may generate the first workspace and/or the second workspace in response to a user input for a visual object for generating a workspace. For example, while activating a first display mode, the electronic device 201 may generate the first workspace and/or the second workspace in response to the user input for the visual object for generating the workspace. In an embodiment, while activating the first display mode, the electronic device 201 may display the generated workspace via the display 220 in response to generating the workspace (e.g., the first workspace or the second workspace). For example, the electronic device 201 may switch a display mode from the first display mode to the second display mode in response to displaying the generated workspace via the display 220. However, the embodiment is not limited thereto.

According to an embodiment, the electronic device 201 may generate the first workspace and/or the second workspace in response to the user input for the visual object for generating the workspace while activating the second display mode. As a non-limiting example, the visual object for generating the workspace may be included in an execution history screen. For example, while the execution history screen is displayed via the display 220, the electronic device 201 may generate the first workspace and/or the second workspace in response to the user input for the visual object for generating the workspace.

According to an embodiment, the electronic device 201 may generate the first workspace and/or the second workspace using a launcher application (e.g., a launcher application 271).

In operation 363, the electronic device 201 may identify the external display device (e.g., the external display device 102) connected to the electronic device 201. For example, the external display device may be used to output the second workspace.

According to an embodiment, the electronic device 201 may be connected to one or more external display devices. As a non-limiting example, the electronic device 201 may generate one or more workspaces in response to identifying that it is connected to the one or more external display devices. For example, the number of the generated one or more workspaces may correspond to the number of the connected one or more external display devices. For example, by generating the one or more workspaces, the number of workspaces included in the electronic device 201 may correspond to the number of the connected one or more external display devices. However, the embodiment is not limited thereto. The electronic device 201 may generate a workspace in response to a user input. For example, since the electronic device 201 may generate the workspace in response to the user input, the number of the workspaces included in the electronic device 201 may be greater than the number of the connected one or more external display devices.

In operation 365, the electronic device 201 may identify the second workspace not being displayed via the display of the electronic device 201 as a workspace to be provided to the external display device. For example, the electronic device 201 may execute the operation 365 based on identifying the external display device connected to the electronic device 201 while the first workspace is displayed via the display (e.g., the display 220) of the electronic device 201.

In operation 367, the electronic device 201 may transmit data for displaying the second workspace to the external display device via the communication circuitry (e.g., the communication circuitry 230). For example, the data for displaying the second workspace may include an image frame (or a video frame) in which rendering on the second workspace has been performed. For example, the external display device may display the second workspace via a display (e.g., a display 140) of the external display device without rendering according to the data for displaying the second workspace.

In operation 369, while the first workspace is displayed via the display and the second workspace is displayed via the external display device, the electronic device 201 may disallow moving a window movable in the first workspace into the second workspace.

According to an embodiment, while the first workspace is displayed via the display and the second workspace is displayed via the external display device, the electronic device 201 may disallow moving a window movable in the second workspace into the first workspace.

According to an embodiment, while the first workspace is displayed via the display and the second workspace is displayed via the external display device, the electronic device 201 may allow moving a pointer (e.g., a pointer 305) between the first workspace and the second workspace.

According to an embodiment, while the first workspace is displayed via the display and the second workspace is displayed via the external display device, the electronic device 201 may identify a user input for an application object included in the first workspace using the pointer. The electronic device 201 may execute an application corresponding to the application object. The electronic device 201 may generate, display, or render a window including both an execution screen of the application and window control buttons in the first workspace. For example, while the window is generated in the first workspace, the second workspace may be maintained.

According to an embodiment, while the first workspace is displayed via the display and the second workspace is displayed via the external display device, the electronic device 201 may identify a user input for an application object included in the second workspace using the pointer. The electronic device 201 may execute an application corresponding to the application object. The electronic device 201 may provide data for generating or displaying a window including both an execution screen of the application and window control buttons in the second workspace to the external display device. For example, while the window is generated in the second workspace, the first workspace may be maintained.

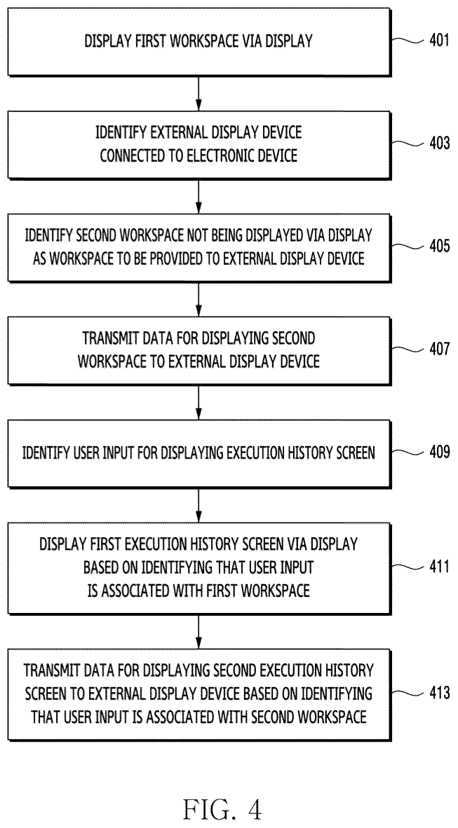

FIG. 4 illustrates an example of operations of an electronic device for adaptively displaying an execution history screen according to a user input.

Referring to FIG. 4, in operation 401, the electronic device 201 may display a first workspace via a display (e.g., a display 220). The operation 401 may correspond to the operation 361 of FIG. 3C.

In operation 403, the electronic device 201 may identify an external display device (e.g., an external display device 102) connected to the electronic device. The operation 403 may correspond to the operation 363 of FIG. 3C.

In operation 405, the electronic device 201 may identify a second workspace not displayed via the display 220 of the electronic device 201 as a workspace to be provided to the external display device. The operation 405 may correspond to the operation 365 of FIG. 3C.

In operation 407, the electronic device 201 may transmit data for displaying the second workspace to the external display device (e.g., the external display device 102) via communication circuitry (e.g., communication circuitry 230). The operation 407 may correspond to the operation 367 of FIG. 3C.

In operation 409, the electronic device 201 may identify a user input for displaying an execution history screen. For example, the electronic device 201 may identify an input for a visual object for displaying the execution history screen. For example, the electronic device 201 may identify a gesture input for displaying the execution history screen.

In operation 411, the electronic device 201 may display a first execution history screen via the display (e.g., the display 220) based on identifying that the user input is associated with the first workspace. For example, the user input associated with the first workspace may include an input for a first visual object for displaying the first execution history screen included in the first workspace or an input for a contact point identified as being positioned within the first workspace. For example, the user input associated with the first workspace may include an input received while a pointer (e.g., a pointer 305) is positioned within the first workspace.

According to an embodiment, while the first workspace is displayed via the display and the second workspace is displayed via the external display device (e.g., the external display device 102), the electronic device 201 may change a state of the first workspace according to the user input associated with the first workspace and maintain a state of the second workspace. For example, the user input associated with the first workspace may include an input for a visual object for displaying the execution history screen positioned within the first workspace. For example, the electronic device 201 may display the execution history screen via the display in response to the input for the visual object.

In operation 413, the electronic device 201 may transmit data for displaying a second execution history screen to the external display device based on identifying that a user input is associated with the second workspace. For example, the user input associated with the second workspace may include an input for a second visual object for displaying the second execution history screen included (or positioned) in the second workspace or an input for a contact point identified as positioned within the second workspace. For example, the user input associated with the second workspace may include an input received while the pointer (e.g., the pointer 305) is positioned within the second workspace.

According to an embodiment, while the first workspace is displayed via the display and the second workspace is displayed via the external display device (e.g., the external display device 102), the electronic device 201 may change a state of the second workspace according to the user input associated with the second workspace and maintain the state of the first workspace. For example, the user input associated with the second workspace may include an input for a visual object for displaying the execution history screen positioned within the second workspace. For example, the electronic device 201 may transmit or provide data for displaying the execution history screen to the external display device in response to the input for the visual object. For example, the execution history screen may be displayed via the external display device.

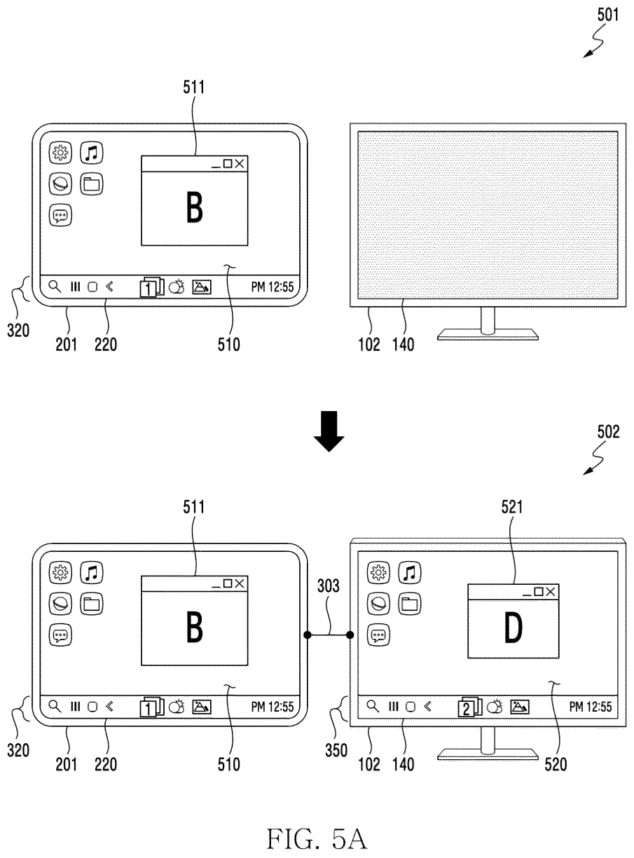

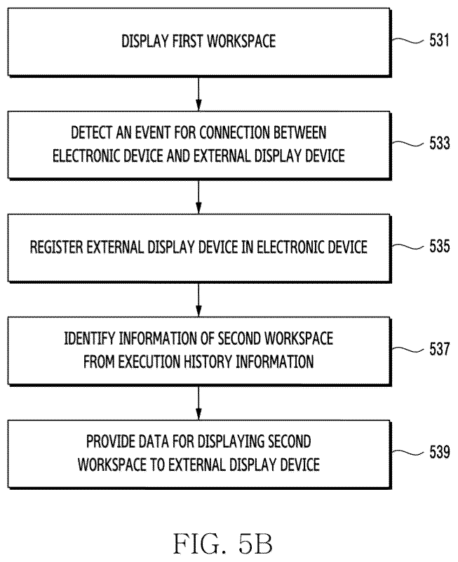

FIG. 5A illustrates an example of a workspace displayed in an external display device according to a connection between an electronic device and the external display device.

Referring to FIG. 5A, in an example 501, the electronic device 201 may not establish a connection with an external display device 102. The electronic device 201 may be in a state of activating a second display mode. For example, the electronic device 201 may display a workspace 510 via a display 220. For example, the workspace 510 may include a window 511 and/or a taskbar 320. For example, the window 511 may include an execution screen of an application (e.g., a B application) and window control buttons.

In an example 502, the electronic device 201 may be connected to the external display device 102. For example, the electronic device 201 may establish a connection 303 with the external display device 102. For example, the connection 303 may include a wireless connection performed using communication circuitry (e.g., communication circuitry 230) or a wired connection performed using the communication circuitry (e.g., the communication circuitry 230).

According to an embodiment, the electronic device 201 may generate a workspace 520 in response to establishing the connection 303 with the external display device 102, but an embodiment is not limited thereto.

According to an embodiment, the electronic device 201 may generate the workspace 520 before establishing the connection 303 with the external display device 102.

According to an embodiment, the electronic device 201 may identify the connected external display device 102 by using a window management module (e.g., a window management module 275). The electronic device 201 may reflect information on the external display device 102 to a system by using the window management module.

According to an embodiment, in response to establishing the connection 303 with the external display device 102, the electronic device 201 may transmit or provide data for displaying the workspace 520 to the external display device 102 using the communication circuitry via the connection 303. The external display device 102 may display the workspace 520. For example, the workspace 520 may include a window 521 and/or a taskbar 350. For example, the window 521 may include an execution screen of an application (e.g., a D application) and window control buttons.

According to an embodiment, the workspace 520 displayed by the external display device 102 and the workspace 510 displayed via the display 220 of the electronic device 201 may be independent. For example, independent of the external display device 102 displaying the workspace 520, the workspace 510 displayed via the display 220 of the electronic device 201 may be maintained. For example, while the workspace 510 displayed via the display 220 of the electronic device 201 is maintained, the external display device 102 may display the workspace 520 via a display 140. A user of the electronic device 201 may perform an independent operation using each of the workspace 510 and the workspace 520.

FIG. 5B illustrates an example of operations of an electronic device displaying a workspace via an external display device.

Referring to FIG. 5B, in operation 531, the electronic device 201 may display a first workspace (e.g., a workspace 510) via a display (e.g., a display 220).

In operation 533, the electronic device 201 may detect an event for a connection (e.g., a connection 303) between the electronic device 201 and an external display device (e.g., an external display device 102). For example, the event may include searching for the external display device connectable wirelessly and/or identifying that a wired interface is inserted into a port of the electronic device 201. For example, the electronic device 201 may detect the event using a launcher application (e.g., a launcher application 271). For example, the electronic device 201 may identify the connection between the electronic device 201 and the external display device using the launcher application. For example, in response to identifying the connection, the electronic device 201 may provide a notification for the connection to a window management module (e.g., a window management module 275) using the launcher application.

In operation 535, the electronic device 201 may register the external display device (e.g., the external display device 102) in the electronic device 201. The electronic device 201 may obtain or generate identification information of the external display device 102 by using the window management module (e.g., the window management module 275). However, an embodiment is not limited thereto.

According to an embodiment, the electronic device 201 may register the external display device 102 in the electronic device 201 in an exemplary case that there is no connection history between the electronic device 201 and the external display device 102.

According to an embodiment, in a case that there is a connection history between the electronic device 201 and the external display device 102, the electronic device 201 may refrain from performing a process of registering the external display device 102. For example, in a case that there is a connection history between the electronic device 201 and the external display device 102, the electronic device 201 may obtain the identification information of the external display device 102 from the connection history.

In operation 537, the electronic device 201 may identify information of a second workspace (e.g., a workspace 520) from execution history information (e.g., execution history information 277). For example, the electronic device 201 may update the information of the second workspace from the execution history information in order to output the second workspace via the external display device. As a non-limiting example, the electronic device 201 may generate the second workspace using the information of the second workspace. However, the embodiment is not limited thereto.

According to an embodiment, in an exemplary case that there is no pre-generated second workspace, the electronic device 201 may generate a third workspace based on detecting the event for the connection between the electronic device 201 and the external display device 102. For example, the electronic device 201 may create the third workspace independently of the execution history information.

In operation 539, the electronic device 201 may provide data for displaying the second workspace to the external display device (e.g., the external display device 102). For example, the electronic device 201 may transmit the data to the external display device using communication circuitry (e.g., communication circuitry 230) via the connection (e.g., the connection 303). For example, the electronic device 201 may provide the data for displaying the second workspace to the external display device by using the window management module (e.g., the window management module 275).

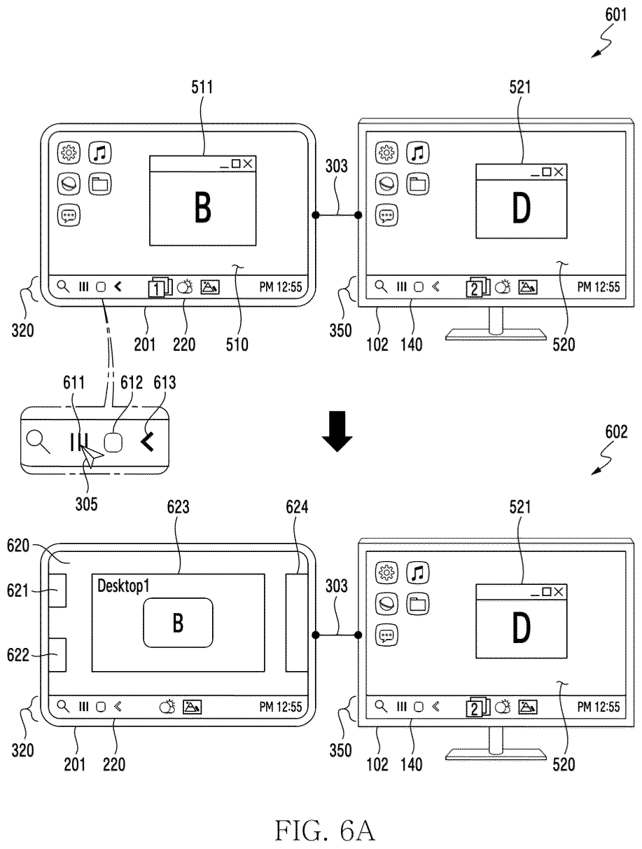

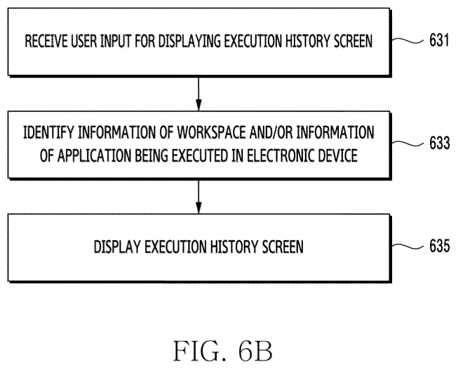

FIG. 6A illustrates an example of an electronic device displaying an execution history screen. An example 601 of FIG. 6A may indicate after the example 502 of FIG. 5A.

Referring to FIG. 6A, in the example 601, the electronic device 201 may display a workspace 510 via a display 220. The electronic device 201 may establish a connection 303 with an external display device 102. The electronic device 201 may transmit data for displaying a workspace 520 to the external display device 102 using communication circuitry (e.g., communication circuitry 230) via the connection 303.

The workspace 510 may include a taskbar 320. The taskbar 320 may include visual objects 611, 612, and 613. The visual object 611 may be referred to as an object for displaying an execution history screen. For example, the execution history screen may be referred to as a recent screen, a recent view, and/or an equivalent technical term thereto. The visual object 612 may be referred to as a home button. For example, the home button may be referred to as an object for displaying a home screen (or a desktop). For example, the visual object 613 may be referred to as a back button.

The electronic device 201 may receive a user input for the visual object 611 using a pointer 305. The electronic device 201 may identify the user input for the visual object 611. In response to the electronic device 201 identifying the user input for the visual object 611, the example 601 may be changed to an example 602.

In the example 602, the electronic device 201 may display an execution history screen 620 via the display 220. For the execution history screen 620, descriptions of the execution history screen providing module 273 of FIG. 2B may be referred to. For example, the execution history screen 620 may include a visual object 621, a visual object 622, a UI object 623, and/or a UI object 624.

The visual objects 621 and 622 may indicate applications that are being executed or have been executed in the electronic device 201. For example, each of the visual objects 621 and 622 may be referred to as an app card. For example, in response to a user input for the visual object 621, the electronic device 201 may display an execution screen of an application indicated by the visual object 621 via the display 220. For example, in response to the user input for the visual object 621, the electronic device 201 may execute the application indicated by the visual object 621 in a foreground. As a non-limiting example, in response to the user input to the visual object 621, the electronic device 201 may display the execution screen of the application via the display 220 according to a first display mode.

The UI object 623 may indicate the workspace 510. The UI object 623 may include at least a portion of an image for a window 511 within the workspace 510. The UI object 623 may be referred to as a workspace card. As a non-limiting example, a size of the UI object 623 may be larger than a size of each of the visual objects 621 and 622. For example, in response to a user input for the UI object 623, the electronic device 201 may display the workspace 510 via the display 220. As a non-limiting example, in response to the user input for the UI object 623, the electronic device 201 may display the window 511 including an execution screen of an application (e.g., a B application) via the display 220 according to a second display mode.

According to an embodiment, based on identifying the user input for the visual object 611 while the display 220 displays the workspace 510 in the example 601, the electronic device 201 may display the execution history screen 620 via the display 220 so that the UI object 623 corresponding to the workspace 510 occupies a central region of a display region of the display 220. For example, the UI object 623 may be focused on the execution history screen 620. For example, a region occupied by the UI object 623 in the display region of the display 220 may be larger than a region occupied by another object (e.g., the visual objects 621 and 622, or the UI object 624).

The UI object 624 may indicate the workspace 520. The UI object 624 may include at least a portion of an image for a window 521 within the workspace 520. The UI object 624 may be referred to as a workspace card.

FIG. 6B illustrates an example of operations of an electronic device for displaying an execution history screen.

Referring to FIG. 6B, in operation 631, the electronic device 201 may receive or identify a user input for displaying an execution history screen. For example, the user input may include an input for a visual object (e.g., a visual object 611) for displaying the execution history screen, and/or a predefined gesture input for displaying the execution history screen.

According to an embodiment, the electronic device 201 may activate an execution history screen providing module (e.g., an execution history screen providing module 273) by using a launcher application (e.g., a launcher application 271).

In operation 633, the electronic device 201 may identify information of a workspace and/or information of an application being executed in the electronic device 201. For example, the application may be executed in a background of the electronic device 201. For example, the electronic device 201 may request the information (e.g., a list of applications) of the application being executed by using the activated execution history screen providing module (e.g., the execution history screen providing module 273). For example, the electronic device 201 may request the information of the generated workspace from a window management module by using the activated execution history screen providing module. For example, the electronic device 201 may identify the information of the application and/or the information of the workspace from execution history information (e.g., execution history information 277) using the window management module. The electronic device 201 may provide the information of the application and/or the information of the workspace to the execution history screen providing module by using the window management module.

In operation 635, the electronic device 201 may display the execution history screen via a display (e.g., a display 220) by using the information of the application and/or the information of the workspace. For example, the execution history screen may be displayed via the display of the electronic device 201 from among the display of the electronic device 201 and a display (e.g., a display 140) of an external display device (e.g., an external display device 102).

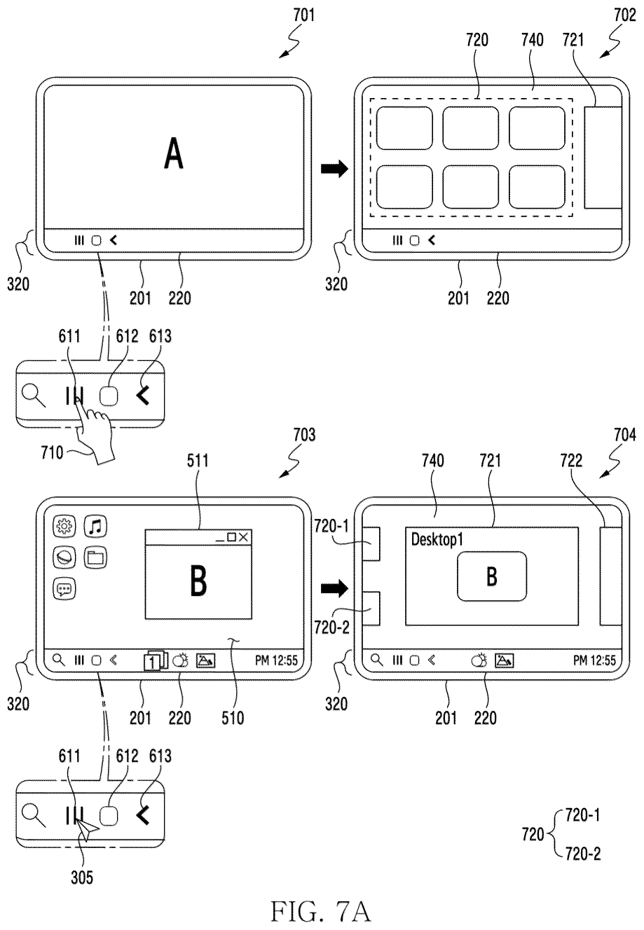

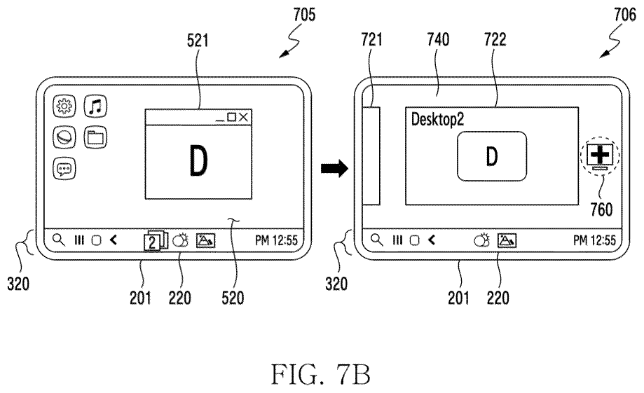

FIGS. 7A and 7B illustrate an example of a visual object and/or a UI object included in an execution history screen.

Referring to FIG. 7A, in an example 701, the electronic device 201 may display an execution screen of an application (e.g., an A application) according to a first display mode via a display 220. The electronic device 201 may receive a user input 710 for a visual object 611 for displaying an execution history screen. In an example 702, the electronic device 201 may display an execution history screen 740 via the display 220 based on the user input 710 for the visual object 611.

In the example 702, the execution history screen 740 may include a plurality of visual objects 720. For example, the plurality of visual objects 720 may be focused on the execution history screen 740. For example, the electronic device 201 may display the execution history screen 740 via the display 220 so that the plurality of visual objects 720 occupy a central region of a display region of the display 220. For example, a region occupied by the plurality of visual objects 720 in the display region of the display 220 may be larger than a region occupied by another object (e.g., a UI object 721).

For example, each of the plurality of visual objects 720 may indicate an application that have been executed or being executed in the electronic device 201. The UI object 721 may be positioned next to the plurality of visual objects 720 in the execution history screen 740. At least a portion of the UI object 721 may be displayed at a periphery of the execution history screen 740.

According to an embodiment, an execution history screen 740 illustrated in an example 704 (to be described later) may be positioned in a right side of the execution history screen 740 illustrated in the example 702. For example, an execution history screen 740 illustrated in an example 706 of FIG. 7B may be positioned in a right side of the execution history screen 740 illustrated in the example 704. For example, in the example 702, the electronic device 201 may receive a user input while displaying the execution history screen 740 via the display 220. For example, the user input may include a swipe input, a drag input, and/or a slide input. For example, the electronic device 201 may display the execution history screen 740 illustrated in the example 704 or the execution history screen 740 illustrated in the example 706 via the display 220 in response to the user input. The electronic device 201 may generate a workspace in response to a user input for a visual object 760 while the execution history screen 740 illustrated in the example 706 is displayed.

In an example 703, the electronic device 201 may display a window 511 including an execution screen of an application (e.g., a B application) according to a second display mode via the display 220. For example, the electronic device 201 may display a workspace 510 via the display 220. The electronic device 201 may identify a user input for the visual object 611 for displaying the execution history screen by using a pointer 305. In the example 704, the electronic device 201 may display the execution history screen 740 via the display 220, based on the user input for the visual object 611.

In the example 704, the execution history screen 740 may include a first visual object 720-1, a second visual object 720-2, a UI object 721, and/or a UI object 722. For example, the UI object 721 may correspond to the workspace 510. For example, the UI object 721 may be focused on the execution history screen 740. For example, the electronic device 201 may display the execution history screen 740 via the display 220 so that the UI object 721 occupies the central region of the display region of the display 220. For example, a region occupied by the UI object 721 in the display region of the display 220 may be larger than a region occupied by another object (e.g., the first visual object 720-1, the second visual object 720-2, or the UI object 722).

Referring to FIG. 7B, in an example 705, the electronic device 201 may display a window 521 including an execution screen of an application (e.g., a D application) according to the second display mode via the display 220. For example, the electronic device 201 may display a workspace 520 via the display 220. The electronic device 201 may change the example 705 to the example 706 according to a user input for displaying the execution history screen 740.

In the example 706, the electronic device 201 may display the execution history screen 740 via the display 220. In the example 706, the execution history screen 740 may include the UI object 721 and/or the UI object 722. For example, the UI object 722 may correspond to the workspace 520. For example, the UI object 722 may be focused on the execution history screen 740. For example, the electronic device 201 may display the execution history screen 740 via the display 220 so that the UI object 722 occupies the central region of the display region of the display 220. For example, a region occupied by the UI object 722 in the display region of the display 220 may be larger than a region occupied by another object (e.g., the UI object 721).

According to an embodiment, the execution history screen 740 may include the visual object 760. For example, the visual object 760 may be positioned in a right side of the UI object 722. For example, the visual object 760 may be positioned in a right periphery of the execution history screen 740. For example, the visual object 760 may be positioned in an end region of the execution history screen 740. However, an embodiment is not limited thereto. For example, the visual object 760 may be positioned in an upper region of the UI object 722. For example, the visual object 760 may be positioned in a lower region of the UI object 722. For example, the visual object 760 may be positioned in a left side of the UI object 722. For example, the visual object 760 may be positioned in a region that is easily accessible to a user of the electronic device 201.

The visual object 760 may be referred to as an object for generating a workspace. For example, the electronic device 201 may generate or render a workspace in response to receiving a user input for the visual object 760.

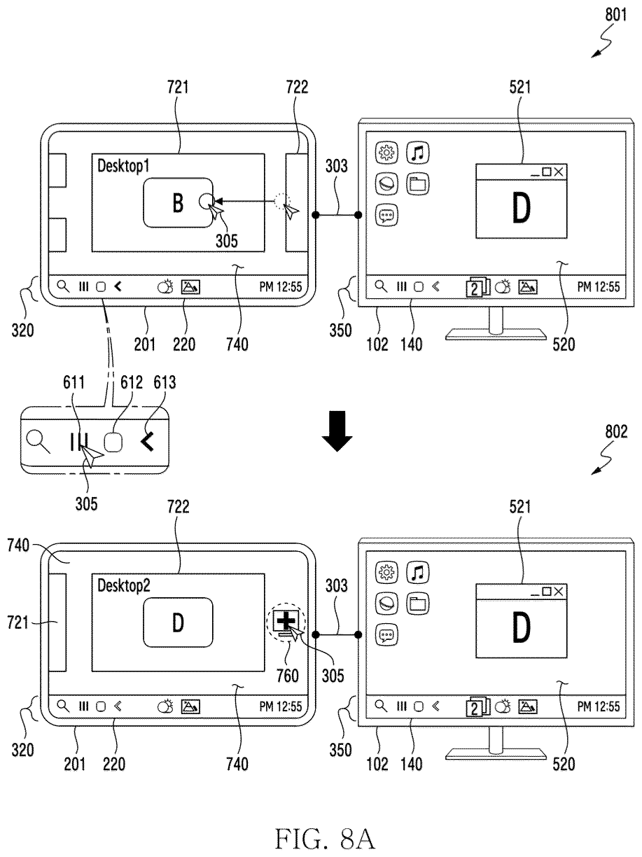

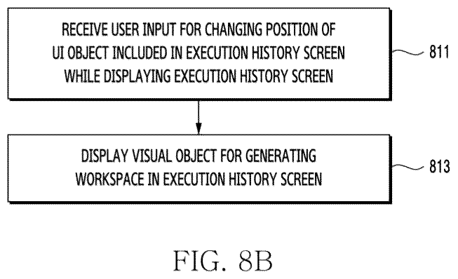

FIG. 8A illustrates an example of an electronic device displaying a visual object for generating a workspace.

Referring to FIG. 8A, in an example 801, the electronic device 201 may display an execution history screen 740 via a display 220. For example, in the example 801, a UI object 721 may be focused. For example, the electronic device 201 may receive a user input while displaying the execution history screen 740. For example, the user input may correspond to a movement of a pointer 305. For example, the user input may include a scroll input, a swipe input, and/or a drag input, but an embodiment is not limited thereto. For example, the user input may be referred to as an input for changing a position of the UI object 721 displayed via a display region of the display 220. The electronic device 201 may display a portion of the execution history screen 740 that is not displayed via the display region of the display 220, via the display region of the display 220 according to the user input. For example, the electronic device 201 may change the example 801 to an example 802 according to the user input.

In the example 802, the electronic device 201 may display the execution history screen 740. For example, a first portion of the execution history screen 740 displayed via the display region of display 220 in the example 802 may be different from a second portion of the execution history screen 740 displayed via the display region of the display 220 in the example 801. For example, the first portion of the execution history screen 740 displayed via the display region of the display 220 in the example 802 may be positioned in a right side of the second portion of the execution history screen 740 displayed via the display region of the display 220 in the example 801. For example, in the example 802, a UI object 722 may be focused.

In the example 802, the electronic device 201 may display a visual object 760 within the execution history screen 740. The visual object 760 may be used to generate a workspace. The electronic device 201 may identify a user input for the visual object 760 using the pointer 305. The electronic device 201 may generate or render a workspace according to the user input for the visual object 760.

FIG. 8B illustrates an example of operations of an electronic device for displaying a visual object for generating a workspace.

Referring to FIG. 8B, in operation 811, the electronic device 201 may receive a user input for changing a position of a UI object included in an execution history screen while displaying the execution history screen via a display (e.g., a display 220). For example, the user input for changing the position of the UI object may include a drag input, a swipe input, and/or a scroll input, but an embodiment is not limited thereto. For example, the electronic device 201 may move the position of the UI object included in the execution history screen in a direction (e.g., a direction from right to left) according to the user input for changing the position of the UI object.

In operation 813, for example, the electronic device 201 may display a visual object (e.g., a visual object 760) for generating a workspace in the execution history screen as the position of the UI object moves in the direction.

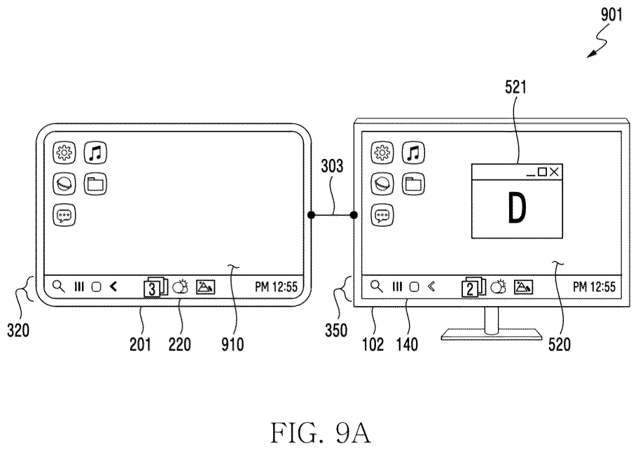

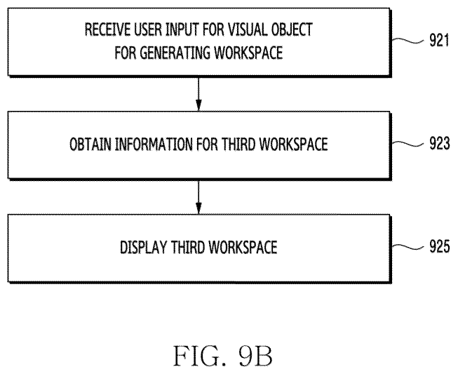

FIG. 9A illustrates an example of an electronic device generating a workspace. FIG. 9A may be referred to after generating the workspace as the electronic device 201 of FIG. 8A identifies the user input for the visual object 760.

Referring to FIG. 9A, the electronic device 201 may display a workspace 910 via a display 220 in response to generating the workspace 910.

According to an embodiment, the electronic device 201 may display the workspace 910 via the display 220 of the electronic device 201 in response to receiving the user input for the visual object 760 displayed via the display 220 of the electronic device 201 in FIG. 8A. For example, an external display device 102 may maintain an operation of displaying a workspace 520 via a display 140. For example, the electronic device 201 may maintain an operation of transmitting data for displaying the workspace 520 to the external display device 102 via communication circuitry (e.g., communication circuitry 230). For example, the electronic device 201 may refrain from transmitting data for displaying the workspace 910 to the external display device 102 via the communication circuitry.

FIG. 9B illustrates an example of operations of an electronic device for displaying a generated workspace.

Referring to FIG. 9B, in operation 921, the electronic device 201 may receive or identify a user input for a visual object (e.g., a visual object 760) for generating a workspace. The electronic device 201 may generate or render a third workspace (e.g., a workspace 910) using a window management module (e.g., a window management module 275) in response to receiving the user input. For example, the electronic device 201 may update information for the third workspace to execution history information (e.g., execution history information 277) using the window management module.

In operation 923, the electronic device 201 may obtain the information for the third workspace (e.g., the workspace 910) from the execution history information (e.g., the execution history information 277). The electronic device 201 may provide the information of the third workspace to a second display mode providing module (e.g., a second display mode providing module 281). The electronic device 201 may request display of the third workspace by providing the information for the third workspace to the second display mode providing module.

In operation 925, the electronic device 201 may display the third workspace (e.g., the workspace 910) via a display (e.g., a display 220). For example, the electronic device 201 may maintain an operation of transmitting data for displaying a workspace (e.g., a workspace 520) to an external display device (e.g., an external display device 102) via communication circuitry (e.g., communication circuitry 230).

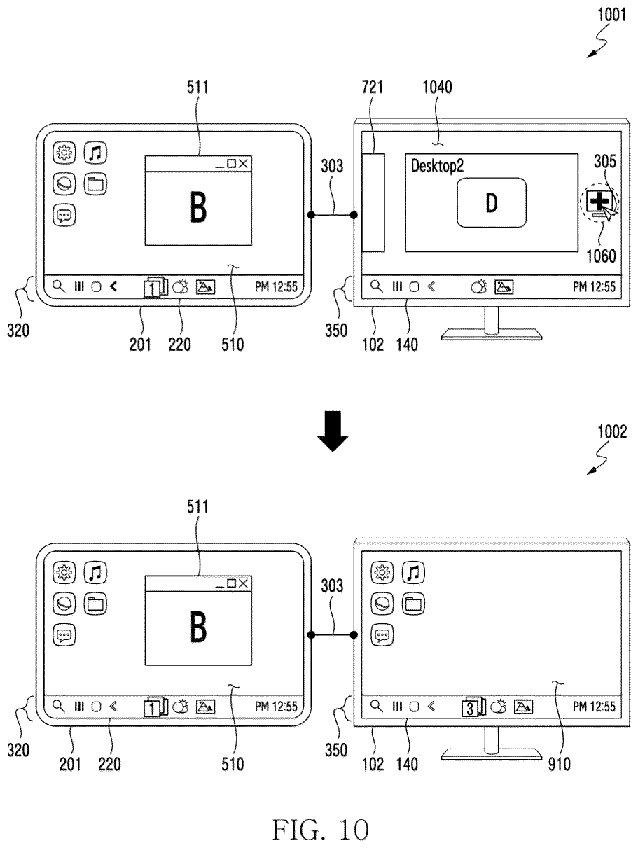

FIG. 10 illustrates an example of an external display device displaying a generated workspace.

Referring to FIG. 10, in an example 1001, the electronic device 201 may display a workspace 510 via a display 220. The electronic device 201 may transmit data for displaying an execution history screen 1040 to an external display device 102 using communication circuitry (e.g., communication circuitry 230) via a connection 303. For example, the external display device 102 may display the execution history screen 1040 via a display 140.

Since the execution history screen 1040 may be substantially the same as the execution history screen 740, a redundant description may be omitted. The execution history screen 1040 may include a visual object 1060 for generating a workspace. The electronic device 201 may identify a user input for the visual object 1060 using a pointer 305.

In an example 1002, the electronic device 201 may generate or render a workspace 910 in response to identifying the user input for the visual object 1060. In response to generating the workspace 910, the electronic device 201 may determine to output the workspace 910 via the external display device 102. For example, in response to generating the workspace 910, the electronic device 201 may transmit or provide data for displaying the workspace 910 to the external display device 102 via the connection 303, by using the communication circuitry. For example, the workspace 910 may be displayed via the display 140 of the external display device 102 from among the display 220 of the electronic device 201 and the display 140 of the external display device 102. For example, the electronic device 201 may maintain an operation of displaying the workspace 510 via the display 220.

According to an embodiment, in response to identifying the user input for the visual object 1060 displayed via the display 140 of the external display device 102, the electronic device 201 may transmit or provide the data for displaying the workspace 910 to the external display device 102 via the connection 303 by using the communication circuitry.

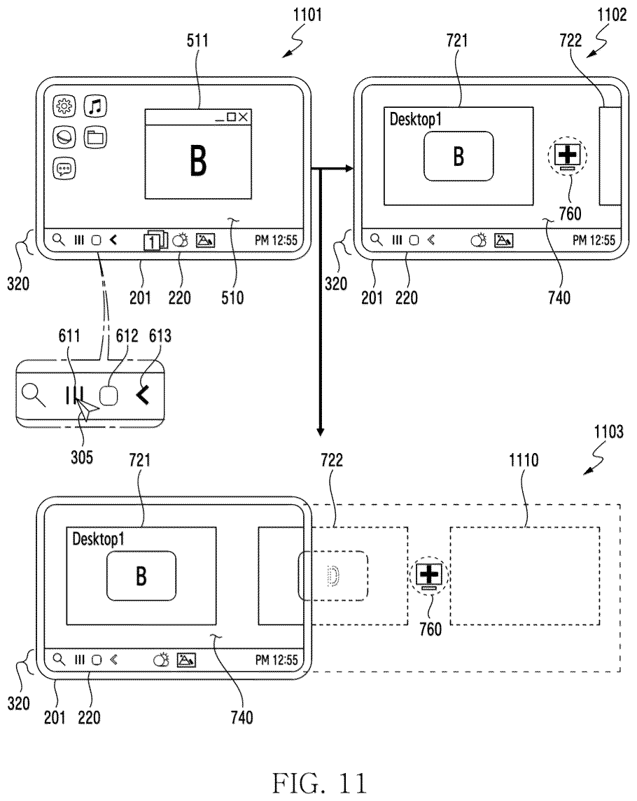

FIG. 11 illustrates an example of an execution history screen including a visual object for generating a workspace. In FIG. 11, the electronic device 201 may include a plurality of workspaces.

Referring to FIG. 11, in an example 1101, the electronic device 201 may display a workspace 510 via a display 220. The electronic device 201 may identify a user input for a visual object 611 for displaying an execution history screen using a pointer 305. The electronic device 201 may change the example 1101 to an example 1102 in response to identifying the user input for the visual object 611 while displaying the workspace 510.

According to an embodiment, in the example 1102, the electronic device 201 may display an execution history screen 740 via the display 220. For example, a UI object 721 may be focused on the execution history screen 740. For example, the UI object 721 may correspond to the workspace 510. For example, the UI object 721 may include at least a portion of an image of a window 511 within the workspace 510. For example, the UI object 721 corresponding to the workspace 510 displayed via the display 220 at a timing when the user input for the visual object 611 is identified may be focused in the example 1102. For example, a visual object 760 for generating a workspace may be positioned next to the UI object 721 focused on the execution history screen 740. For example, the visual object 760 may be positioned in a right side of the UI object 721 focused on the execution history screen 740. For example, the visual object 760 may be positioned between the UI object 721 and a UI object 722.

According to an embodiment, the electronic device 201 may change the example 1101 to an example 1103 in response to identifying the user input for the visual object 611 while displaying the workspace 510. In the example 1103, the electronic device 201 may identify the most recently generated workspace (e.g., a workspace 910) from among workspaces (e.g., workspaces 510, 520, and 910). For example, the visual object 760 may be positioned next to a UI object corresponding to the most recently generated workspace from among the workspaces. For example, a UI object 1110 may correspond to the most recently generated workspace from among the workspaces. For example, the visual object 760 may be positioned next to the UI object 1110 within the execution history screen 740. For example, the visual object 760 may be positioned in a left side of the UI object 1110. For example, the visual object 760 may be positioned between the UI object 722 and the UI object 1110.

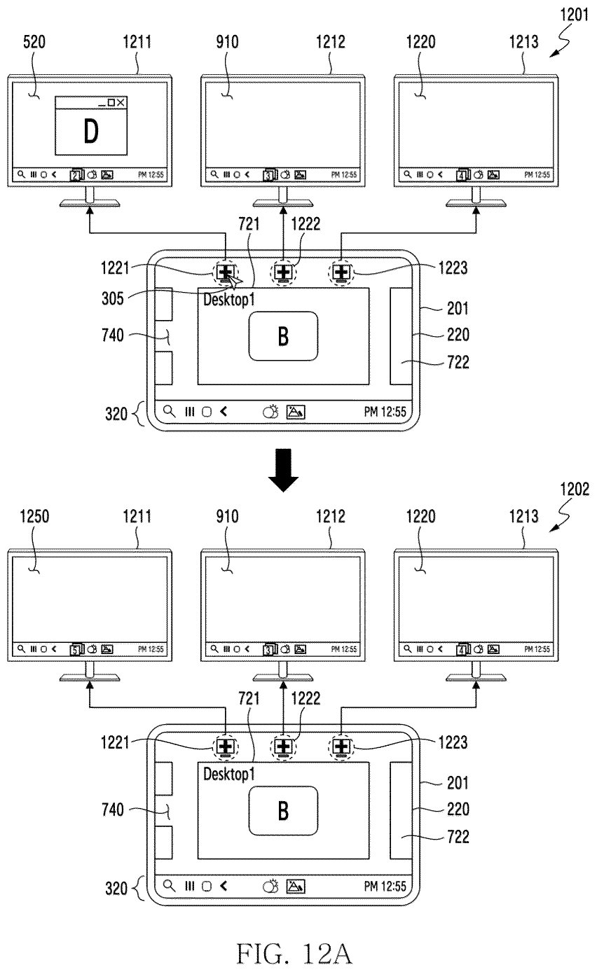

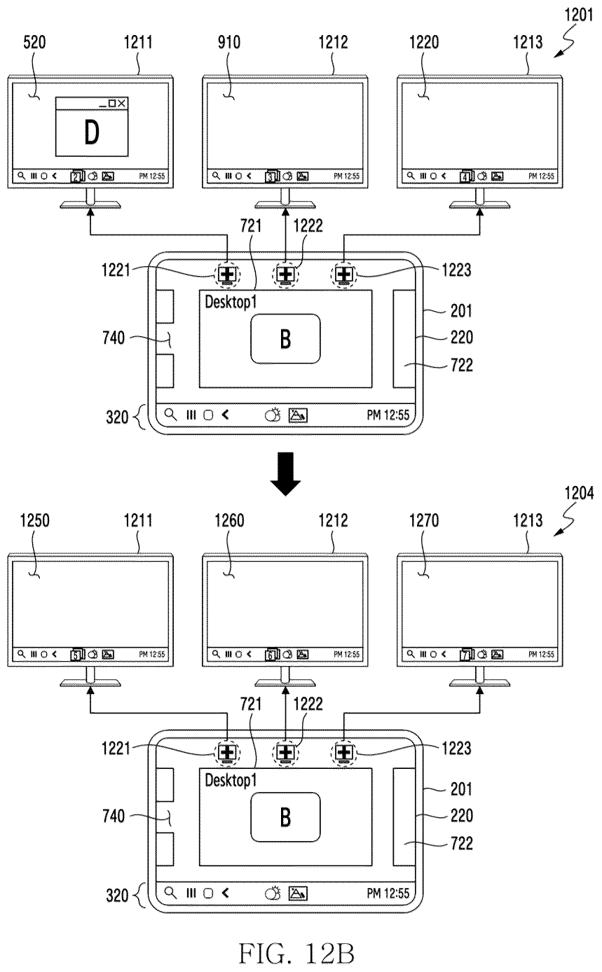

FIGS. 12A and 12B illustrate examples of an electronic device that transmits data for a workspace to an external display device. External display devices 1211, 1212, and 1213 may be an example of the external display device 102 of FIG. 1.

Referring to FIG. 12A, in an example 1201, for example, the electronic device 201 may establish a connection with each of the external display devices 1211, 1212, and 1213, using communication circuitry (e.g., communication circuitry 230). The external display device 1211 may display a workspace 520. The external display device 1212 may display a workspace 910. The external display device 1213 may display a workspace 1220.

According to an embodiment, the electronic device 201 may display an execution history screen 740 via a display 220. For example, the execution history screen 740 may include visual objects 1221, 1222, and 1223.

The visual object 1221 may be referred to as an object for generating a workspace and transmitting data for displaying the generated workspace to the external display device 1211. For example, the electronic device 201 may generate a workspace in response to a user input for the visual object 1221. For example, the electronic device 201 may transmit the data for displaying the generated workspace to the external display device 1211 via the communication circuitry (e.g., the communication circuitry 230).

The visual object 1222 may be referred to as an object for generating a workspace and transmitting data for displaying the generated workspace to the external display device 1212. For example, the electronic device 201 may generate a workspace in response to a user input for the visual object 1222. For example, the electronic device 201 may transmit the data for displaying the generated workspace to the external display device 1212 via the communication circuitry.

The visual object 1223 may be referred to as an object for generating a workspace and transmitting data for displaying the generated workspace to the external display device 1213. For example, the electronic device 201 may generate a workspace in response to a user input for the visual object 1223. For example, the electronic device 201 may transmit the data for displaying the generated workspace to the external display device 1213 via the communication circuitry.

According to an embodiment, in the example 1201, the electronic device 201 may change the example 1201 to an example 1202 in response to identifying the user input for the visual object 1221 using a pointer 305.

In the example 1202, the electronic device 201 may generate a workspace 1250 according to the user input for the visual object 1221. For example, the electronic device 201 may transmit or provide data for displaying the workspace 1250 to the external display device 1211 via the communication circuitry (e.g., communication circuitry 230). For example, the workspace 1250 may be displayed in the external display device 1211.

According to an embodiment, the electronic device 201 may maintain an operation of transmitting data for displaying the workspace 910 to the external display device 1212 via the communication circuitry. The electronic device 201 may maintain an operation of transmitting data for displaying the workspace 1220 to the external display device 1213 via the communication circuitry.

Referring to FIG. 12B, in the example 1201, the electronic device 201 may change the example 1201 to an example 1204 in response to identifying the user input for the visual object 1221, the user input for the visual object 1222, and the user input for the visual object 1223.

In the example 1204, the electronic device 201 may generate the workspace 1250 according to the user input for the visual object 1221. For example, the electronic device 201 may transmit or provide the data for displaying the workspace 1250 to the external display device 1211 via the communication circuitry (e.g., communication circuitry 230). For example, the workspace 1250 may be displayed in the external display device 1211.

The electronic device 201 may generate a workspace 1260 according to the user input for the visual object 1222. For example, the electronic device 201 may transmit or provide data for displaying the workspace 1260 to the external display device 1212 via the communication circuitry. For example, the workspace 1260 may be displayed in the external display device 1212.

The electronic device 201 may generate a workspace 1270 according to the user input for the visual object 1223. For example, the electronic device 201 may transmit or provide data for displaying the workspace 1270 to the external display device 1213 via the communication circuitry. For example, the workspace 1270 may be displayed in the external display device 1213.

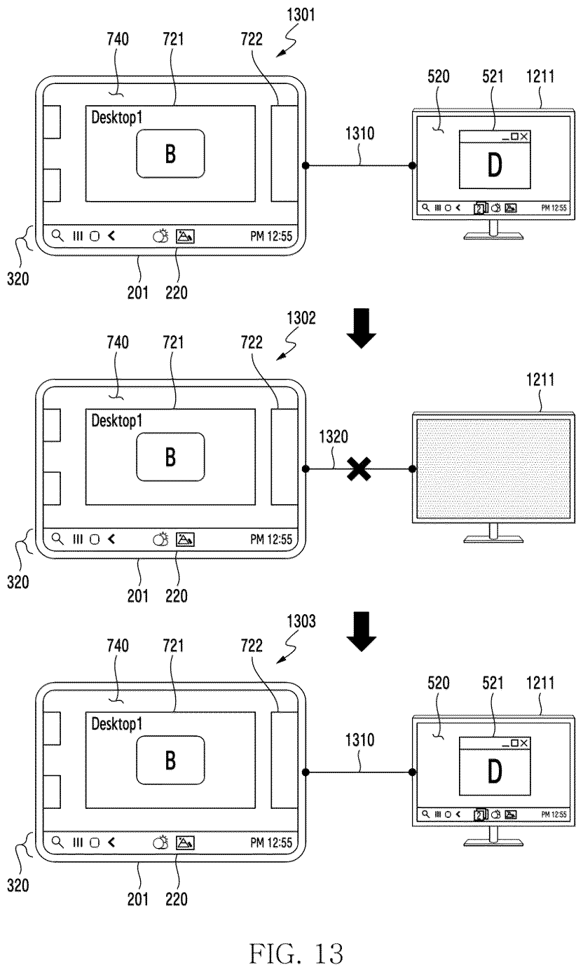

FIG. 13 illustrates an example of an electronic device that stores information for an external display device and information for a workspace displayed in the external display device.

Referring to FIG. 13, in an example 1301, the electronic device 201 may display an execution history screen 740 via a display 220. For example, the electronic device 201 may establish a connection 1310 with an external display device 1211. The external display device 1211 may display a workspace 520.

According to an embodiment, the electronic device 201 may transmit data for displaying the workspace 520 to the external display device 1211 via the connection 1310, using communication circuitry (e.g., communication circuitry 230). The electronic device 201 may store information for the workspace 520 and information for the external display device 1211. For example, the electronic device 201 may store the information for the workspace 520 in conjunction with the information for the external display device 1211. For example, the information for the workspace 520 may include information associated with a size of a window 521 included in the workspace 520, a position of the window 521, and/or an execution screen included in the window 521. For example, the information for the external display device 1211 may include an identifier of the external display device 1211.

In an example 1302, the electronic device 201 may identify a disconnection 1320 (or a release 1320) of the connection 1310 between the electronic device 201 and the external display device 1211. For example, the external display device 1211 may cease or refrain from displaying the workspace 520 based on the disconnection 1320. For example, the external display device 1211 may not display the workspace 520 based on the disconnection 1320.

In an example 1303, the electronic device 201 may identify again the connection 1310 between the electronic device 201 and the external display device 1211. For example, the connection 1310 may be resumed. For example, the electronic device 201 may identify the information for the workspace 520 and the information for the external display device 1211 that are stored in the example 1301 in response to identifying again the connection 1310. For example, the electronic device 201 may identify the information for the workspace 520 and the information for the external display device 1211 in response to identifying that the external display device 1211 is reconnected based on the connection 1310. For example, based on the information for the workspace 520 and the information for the external display device 1211, the electronic device 201 may transmit the data for displaying the workspace 520 to the external display device 1211 via the connection 1310 using the communication circuitry (e.g., the communication circuitry 230). For example, the workspace 520 may be displayed in the external display device 1211.

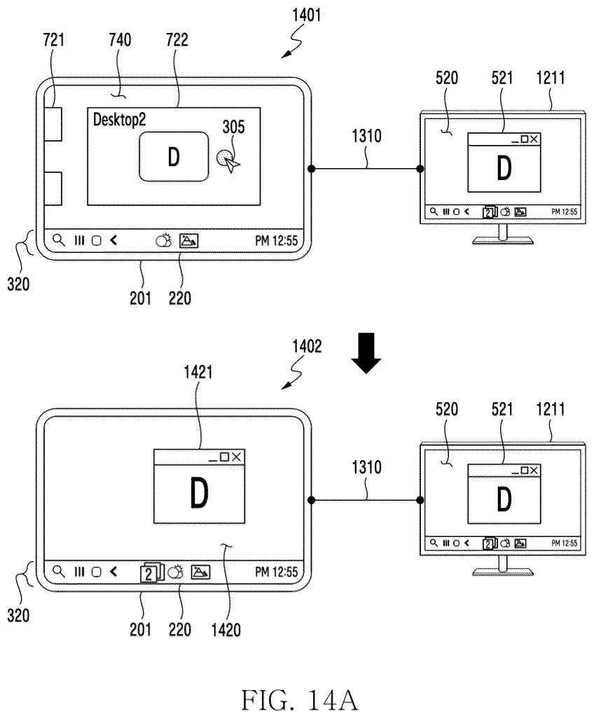

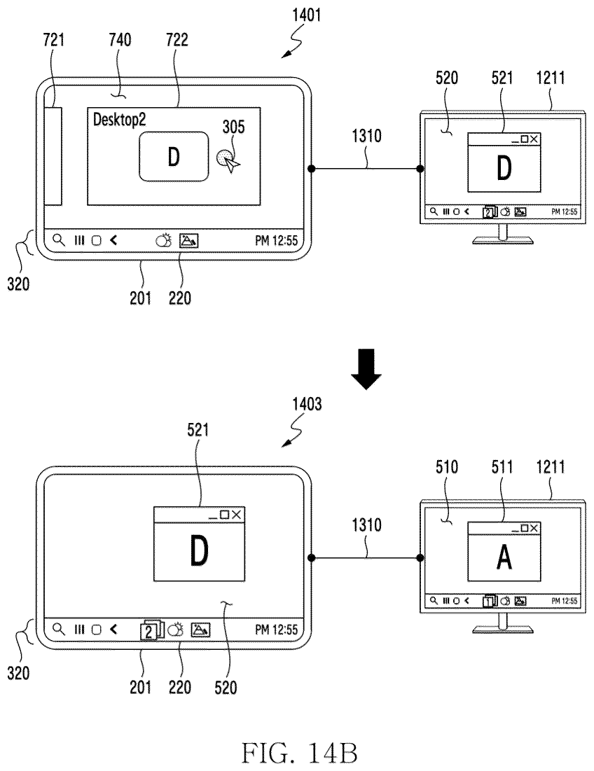

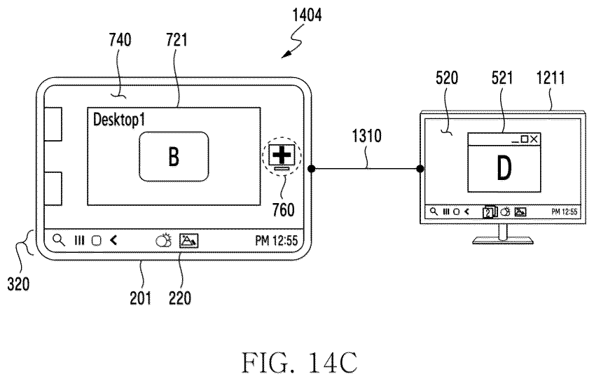

FIGS. 14A, 14B, and 14C illustrate examples of an electronic device that receives a user input for a UI object corresponding to a workspace being displayed in an external display device.

Referring to FIG. 14A, in an example 1401, the electronic device 201 may display an execution history screen 740 via a display 220. For example, the electronic device 201 may establish a connection 1310 with an external display device 1211. The external display device 1211 may display a workspace 520.

According to an embodiment, the electronic device 201 may display a UI object 722 within the execution history screen 740. For example, the UI object 722 may correspond to the workspace 520 displayed in the external display device 1211. The electronic device 201 may receive or identify a user input for the UI object 722. The electronic device 201 may change the example 1401 to an example 1402 in response to receiving the user input for the UI object 722.

According to an embodiment, in the example 1402, the electronic device 201 may display a screen 1420 via the display 220 in response to receiving the user input for the UI object 722. For example, the screen 1420 may be substantially the same as the workspace 520. For example, the screen 1420 may be referred to as a mirroring screen for the workspace 520. As a non-limiting example, the screen 1420 may be the same as the workspace 520. For example, a window 1421 in the screen 1420 may be substantially the same as a window 521. However, an embodiment is not limited thereto.

Referring to FIG. 14B, in the example 1401, the electronic device 201 may change the example 1401 to an example 1403 in response to receiving the user input for the UI object 722.

According to an embodiment, in the example 1403, the electronic device 201 may display the workspace 520 via the display 220 in response to receiving the user input for the UI object 722. For example, in response to receiving a user input, the electronic device 201 may change a workspace displayed via the display 220 from a workspace 510 to the workspace 520. For example, the electronic device 201 may switch or exchange the workspace 510 displayed via the display 220 and the workspace 520 displayed via the external display device 1211.

The external display device 1211 may display the workspace 510. For example, the workspace 510 displayed in the external display device 1211 may be displayed via the display 220 of the electronic device 201. For example, the workspace 510 displayed in the external display device 1211 may be referred to as a screen displayed prior to the execution history screen 740 in the display 220 of the electronic device 201 in the example 1401. For example, the electronic device 201 may provide or transmit data for displaying the workspace 510 to the external display device 1211 via the connection 1310, using communication circuitry.

Referring to FIG. 14C, in an example 1404, the electronic device 201 may display the execution history screen 740 via the display 220. The workspace 520 may be displayed in the external display device 1211.

According to an embodiment, the execution history screen 740 may not include the UI object 722 corresponding to the workspace 520. For example, the electronic device 201 may not display the UI object 722 in the execution history screen 740. For example, the electronic device 201 may not display the UI object 722 in the execution history screen 740 to prevent the user input for the UI object 722. For example, the UI object 722 may be excluded from the execution history screen 740. For example, as the UI object 722 is excluded from the execution history screen 740, a visual object 760 may be positioned next to a UI object 721.

As a non-limiting example, the execution history screen 740 may include the UI object 722 in an inactive state. For example, since the workspace 520 is displayed in the external display device 1211, the UI object 722 may be in the inactive state. For example, the UI object 722 in the inactive state may not be selected or determined by a user input. For example, an appearance of the UI object 722 in the inactive state may be different from an appearance of the UI object 722 in an active state. For example, the UI object 722 in the inactive state may be represented as a gray-processed object.

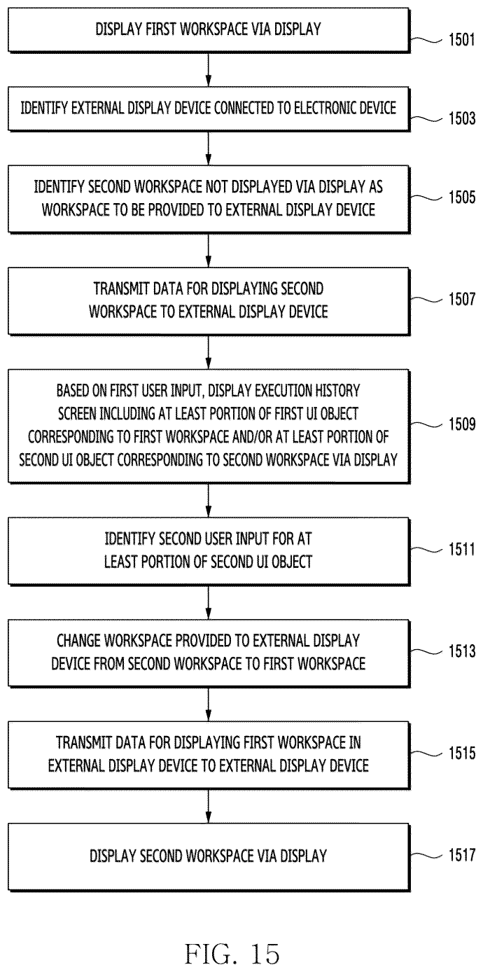

FIG. 15 illustrates an example of operations of changing a workspace displayed via a display of an electronic device. Operations exemplified in FIG. 15 may be associated with FIG. 14B.

Referring to FIG. 15, in operation 1501, the electronic device 201 may display a first workspace via a display (e.g., a display 220). The operation 1501 may correspond to the operation 361 of FIG. 3C.

In operation 1503, the electronic device 201 may identify an external display device (e.g., an external display device 102) connected to the electronic device 201 via communication circuitry (e.g., communication circuitry 230). The operation 1503 may correspond to the operation 363 of FIG. 3C.

In operation 1505, the electronic device 201 may identify a second workspace not displayed via the display 220 of the electronic device 201 as a workspace to be provided to the external display device 102. The operation 1505 may correspond to the operation 365 of FIG. 3C.

In operation 1507, the electronic device 201 may transmit data for displaying the second workspace to the external display device (e.g., the external display device 102) via the communication circuitry (e.g., the communication circuitry 230). The operation 1507 may correspond to the operation 367 of FIG. 3C.

In operation 1509, based on a first user input, the electronic device 201 may display an execution history screen (e.g., an execution history screen 740) including at least a portion of a first UI object (e.g., a UI object 721) corresponding to the first workspace and/or at least a portion of a second UI object (e.g., a UI object 722) corresponding to the second workspace via the display 220. For example, the electronic device 201 may receive the first user input while the first workspace is displayed via the display 220 of the electronic device 201 and/or the second workspace is displayed via the external display device (e.g., the external display device 102). For example, the first user input may be referred to as an input for displaying the execution history screen via the display 220.

According to an embodiment, based on receiving the first user input, the electronic device 201 may maintain an operation of transmitting the data for displaying the second workspace in the external display device 102 to the external display device 102 via the communication circuitry 230.

According to an embodiment, the execution history screen displayed via the display 220 of the electronic device 201 may further include a visual object (e.g., a visual object 760) for generating a workspace. For example, the electronic device 201 may generate a third workspace based on a third user input for the visual object. For example, the generated third workspace may be displayed via the display 220. For example, while the third workspace is displayed via the display 220, it may be maintained that the second workspace is displayed in the external display device 102.

In operation 1511, the electronic device 201 may identify a second user input for the at least a portion of the second UI object. For example, the electronic device 201 may identify the second user input while the execution history screen is displayed via the display.

In operation 1513, the electronic device 201 may change or switch the workspace provided to the external display device 102 from the second workspace to the first workspace based on the second user input. For example, the electronic device 201 may identify or determine a workspace to be displayed via the display 220 as the second workspace.

In operation 1515, based on the second user input, the electronic device 201 may transmit data for displaying the first workspace in the external display device 102 to the external display device 102 via the communication circuitry 230. For example, based on the second user input, the electronic device 201 may cease to transmit the data for displaying the second workspace in the external display device 102 and may display the data for displaying the first workspace in the external display device 102 via the communication circuitry 230. For example, a workspace displayed in the external display device 102 may be changed or switched from the second workspace to the first workspace.

In operation 1517, the electronic device 201 may display the second workspace via the display 220 based on the second user input. For example, a workspace displayed via the display 220 may be switched from the first workspace to the second workspace.

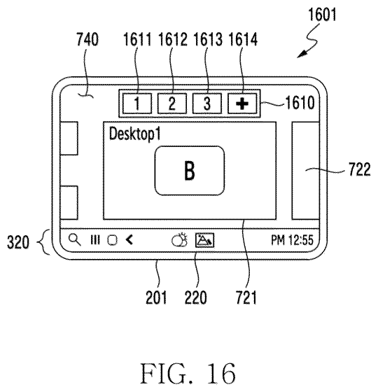

FIG. 16 illustrates an example of an execution history screen.

Referring to FIG. 16, in an example 1601, the electronic device 201 may display an execution history screen 740 via a display 220. According to an embodiment, the execution history screen 740 may include a UI sheet 1610. The UI sheet 1610 may include UI objects 1611, 1612, 1613, and 1614.

The UI object 1611 may correspond to a first workspace from among a plurality of workspaces generated in the electronic device 201. For example, the electronic device 201 may display the first workspace via the display 220 in response to a user input for the UI object 1611. As a non-limiting example, the electronic device 201 may perform a focus for a UI object corresponding to the first workspace in response to the user input for the UI object 1611. For example, the electronic device 201 may display the UI object corresponding to the first workspace using a display region of the display 220 in response to the user input for the UI object 1611. For example, the electronic device 201 may change the execution history screen 740 so that the UI object corresponding to the first workspace is displayed in the display region of the display 220.

The UI object 1612 may correspond to a second workspace from among the plurality of workspaces generated in the electronic device 201. For example, the electronic device 201 may display the second workspace via the display 220 in response to a user input for the UI object 1612. As a non-limiting example, the electronic device 201 may perform a focus for a UI object corresponding to the second workspace in response to the user input for the UI object 1612. For example, the electronic device 201 may display the UI object corresponding to the second workspace using the display region of the display 220 in response to the user input for the UI object 1612. For example, the electronic device 201 may change the execution history screen 740 so that the UI object corresponding to the second workspace is displayed in the display region of the display 220.

The UI object 1613 may correspond to a third workspace from among the plurality of workspaces generated in the electronic device 201. For example, the electronic device 201 may display the third workspace via the display 220 in response to a user input for the UI object 1613. As a non-limiting example, the electronic device 201 may perform a focus for a UI object corresponding to the third workspace in response to the user input for the UI object 1613. For example, the electronic device 201 may display the UI object corresponding to the third workspace using the display region of the display 220 in response to the user input for the UI object 1613. For example, the electronic device 201 may change the execution history screen 740 so that the UI object corresponding to the third workspace is displayed in the display region of the display 220.

The UI object 1614 may be referred to as an object for generating a workspace. For example, the electronic device 201 may generate or render a workspace in response to identifying a user input for the UI object 1614. For example, a function of the UI object 1614 and a function of a visual object 760 may be substantially the same.

FIG. 17 is a block diagram of an electronic device in a network environment according to various embodiments. For example, an electronic device 1701 may include the electronic device 201 of FIG. 2A.

Referring to FIG. 17, the electronic device 1701 in the network environment 1700 may communicate with an electronic device 1702 via a first network 1798 (e.g., a short-range wireless communication network), or at least one of an electronic device 1704 or a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identification module(SIM) 1796, or an antenna module 1797. In some embodiments, at least one of the components (e.g., the connecting terminal 1778) may be omitted from the electronic device 1701, or one or more other components may be added in the electronic device 1701. In some embodiments, some of the components (e.g., the sensor module 1776, the camera module 1780, or the antenna module 1797) may be implemented as a single component (e.g., the display module 1760).

The processor 1720 may execute, for example, software (e.g., a program 1740) to control at least one other component (e.g., a hardware or software component) of the electronic device 1701 coupled with the processor 1720, and may perform various data processing or computation. According to an embodiment, as at least part of the data processing or computation, the processor 1720 may store a command or data received from another component (e.g., the sensor module 1776 or the communication module 1790) in volatile memory 1732, process the command or the data stored in the volatile memory 1732, and store resulting data in non-volatile memory 1734. According to an embodiment, the processor 1720 may include a main processor 1721 (e.g., a central processing unit (CPU) or an application processor (AP)), or an auxiliary processor 1723 (e.g., a graphics processing unit (GPU), a neural processing unit (NPU), an image signal processor (ISP), a sensor hub processor, or a communication processor (CP)) that is operable independently from, or in conjunction with, the main processor 1721. For example, when the electronic device 1701 includes the main processor 1721 and the auxiliary processor 1723, the auxiliary processor 1723 may be adapted to consume less power than the main processor 1721, or to be specific to a specified function. The auxiliary processor 1723 may be implemented as separate from, or as part of the main processor 1721.

The auxiliary processor 1723 may control at least some of functions or states related to at least one component (e.g., the display module 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). According to an embodiment, the auxiliary processor 1723 (e.g., an image signal processor or a communication processor) may be implemented as part of another component (e.g., the camera module 1780 or the communication module 1790) functionally related to the auxiliary processor 1723. According to an embodiment, the auxiliary processor 1723 (e.g., the neural processing unit) may include a hardware structure specified for artificial intelligence model processing. An artificial intelligence model may be generated by machine learning. Such learning may be performed, e.g., by the electronic device 1701 where the artificial intelligence is performed or via a separate server (e.g., the server 1708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734.

The program 1740 may be stored in the memory 1730 as software, and may include, for example, an operating system (OS) 1742, middleware 1744, or an application 1746.

The input module 1750 may receive a command or data to be used by another component (e.g., the processor 1720) of the electronic device 1701, from the outside (e.g., a user) of the electronic device 1701. The input module 1750 may include, for example, a microphone, a mouse, a keyboard, a key (e.g., a button), or a digital pen (e.g., a stylus pen).

The sound output module 1755 may output sound signals to the outside of the electronic device 1701. The sound output module 1755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1760 may visually provide information to the outside (e.g., a user) of the electronic device 1701. The display module 1760 may include, for example, a display, a hologram device, or a projector and control circuitry to control a corresponding one of the display, hologram device, and projector. According to an embodiment, the display module 1760 may include a touch sensor adapted to detect a touch, or a pressure sensor adapted to measure the intensity of force incurred by the touch.

The audio module 1770 may convert a sound into an electrical signal and vice versa. According to an embodiment, the audio module 1770 may obtain the sound via the input module 1750, or output the sound via the sound output module 1755 or a headphone of an external electronic device (e.g., an electronic device 1702) directly (e.g., through a wire or wires) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly (e.g., through a wire or wires) or wirelessly. According to an embodiment, the interface 1777 may include, for example, a high definition multimedia interface (HDMI), a universal serial bus (USB) interface, a secure digital (SD) card interface, or an audio interface.

A connecting terminal 1778 may include a connector via which the electronic device 1701 may be physically connected with the external electronic device (e.g., the electronic device 1702). According to an embodiment, the connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or electrical stimulus which may be recognized by a user via his tactile sensation or kinesthetic sensation. According to an embodiment, the haptic module 1779 may include, for example, a motor, a piezoelectric element, or an electric stimulator.

The camera module 1780 may capture a still image or moving images. According to an embodiment, the camera module 1780 may include one or more lenses, image sensors, image signal processors, or flashes.

The power management module 1788 may manage power supplied to the electronic device 1701. According to an embodiment, the power management module 1788 may be implemented as at least part of, for example, a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the application processor (AP)) and supports a direct (e.g., wired) communication or a wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as Bluetooth™, wireless-fidelity (Wi-Fi) direct, or infrared data association (IrDA)) or the second network 1799 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The wireless communication module 1792 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., the mmWave band) to achieve, e.g., a high data transmission rate. The wireless communication module 1792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20Gbps or more) for implementing eMBB, loss coverage (e.g., 1764 dB or less) for implementing mMTC, or U-plane latency (e.g., 0.5 ms or less for each of downlink (DL) and uplink (UL), or a round trip of 17 ms or less) for implementing URLLC.

The antenna module 1797 may transmit or receive a signal or power to or from the outside (e.g., the external electronic device) of the electronic device 1701. According to an embodiment, the antenna module 1797 may include an antenna including a radiating element composed of a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in the communication network, such as the first network 1798 or the second network 1799, may be selected, for example, by the communication module 1790 (e.g., the wireless communication module 1792) from the plurality of antennas. The signal or the power may then be transmitted or received between the communication module 1790 and the external electronic device via the selected at least one antenna. According to an embodiment, another component (e.g., a radio frequency integrated circuit (RFIC)) other than the radiating element may be additionally formed as part of the antenna module 1797.

According to various embodiments, the antenna module 1797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the electronic devices 1702 or 1704 may be a device of a same type as, or a different type, from the electronic device 1701. According to an embodiment, all or some of operations to be executed at the electronic device 1701 may be executed at one or more of the external electronic devices 1702, 1704, or 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra-low-latency services using, e.g., distributed computing or mobile edge computing. In another embodiment, the external electronic device 1704 may include an internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., smart home, smart city, smart car, or healthcare) based on 5G communication technology or IoT-related technology.

In an embodiment according to the present disclosure, an electronic device (e.g., the electronic device 201) may display a workspace via a display (e.g., the display 220) of the electronic device 201. For example, the electronic device 201 may display a second workspace via the display while a first workspace is displayed in an external display device (e.g., the external display device 102) connected to the electronic device 201. The electronic device 201 may provide a multi-screen environment to a user of the electronic device 201. For example, by providing the multi-screen environment to the user of the electronic device, a work productivity of the user of the electronic device may increase. A user experience of the electronic device may be enhanced.

The effects that can be obtained from the present disclosure are not limited to those described above, and any other effects not mentioned herein will be understood by those having ordinary knowledge in the art to which the present disclosure belongs, from the following description.

The technical problems to be achieved in this document are not limited to those described above, and other technical problems not mentioned herein will be understood by those having ordinary knowledge in the art to which the present disclosure belongs, from the following description.

As described above, an electronic device may include a display. The electronic device may include communication circuitry. The electronic device may include memory including one or more storage media storing instructions. The electronic device may include at least one processor including processing circuitry. The instructions, when executed by the at least one processor individually or collectively, may cause the electronic device to generate a first workspace and a second workspace each configured to display an execution screen in a window having window control buttons. The instructions, when executed by the at least one processor individually or collectively, may cause the electronic device to display, via the display, the first workspace from among the first workspace and the second workspace. The instructions, when executed by the at least one processor individually or collectively, may cause the electronic device to identify an external display device connected to the electronic device, via the communication circuitry. The instructions, when executed by the at least one processor individually or collectively, may cause the electronic device to, based on identifying the external display device being connected to the electronic device while the first workspace is displayed, identify the second workspace not displayed via the display as a workspace to be provided in the external display device. The instructions, when executed by the at least one processor individually or collectively, may cause the electronic device to transmit data for displaying the second workspace in the external display device, to the external display device, via the communication circuitry. The instructions, when executed by the at least one processor individually or collectively, may cause the electronic device to, based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace. The instructions, when executed by the at least one processor individually or collectively, may cause the electronic device to, while the execution history screen is displayed via the display, identify a second user input for the at least a portion of the second UI object corresponding to the second workspace. The instructions, when executed by the at least one processor individually or collectively, may cause the electronic device to, based on the second user input, change a workspace to be provided in the external display device from the second workspace to the first workspace. The instructions, when executed by the at least one processor individually or collectively, may cause the electronic device to, based on the second user input, transmit data for displaying the first workspace in the external display device, to the external display device, via the communication circuitry. The instructions, when executed by the at least one processor individually or collectively, may cause the electronic device to, based on the second user input, display, via the display, the second workspace.

According to an embodiment, the execution history screen may include a visual object for generating a workspace. The instructions, when executed by the at least one processor individually or collectively, may cause the electronic device to, while the execution history screen is displayed via the display, identify a third user input for the visual object included in the execution history screen. The instructions, when executed by the at least one processor individually or collectively, may cause the electronic device to, based on the third user input for the visual object, generate a third workspace. The instructions, when executed by the at least one processor individually or collectively, may cause the electronic device to, based on the third user input for the visual object, display, via the display, the third workspace from among the first workspace, the second workspace, and the third workspace.

According to an embodiment, the instructions, when executed by the at least one processor individually or collectively, may cause the electronic device to, based on the third user input for the visual object, maintain an operation of transmitting the data for displaying the second workspace in the external display device, to the external display device, via the communication circuitry.

According to an embodiment, the instructions, when executed by the at least one processor individually or collectively, may cause the electronic device to, based on the first user input, maintain an operation of transmitting the data for displaying the second workspace in the external display device, to the external display device, via the communication circuitry.

According to an embodiment, the first user input may include an input for a first visual object for displaying the first execution history screen included in the first workspace or an input for a contact point identified as being positioned within the first workspace.

According to an embodiment, the execution history screen may be a first execution history screen. The first user input may be a user input for displaying the first execution history screen via the display. The instructions, when executed by the at least one processor individually or collectively, may cause the electronic device to: while the first workspace is displayed via the display of the electronic device and the second workspace is displayed in the external display device, identify a third user input for displaying a second execution history screen corresponding to the first execution history screen in the external display device. The instructions, when executed by the at least one processor individually or collectively, may cause the electronic device to, based on the third user input, maintain an operation of displaying the first workspace via the display. The instructions, when executed by the at least one processor individually or collectively, may cause the electronic device to, based on the third user input, transmit data for displaying the second workspace in the external display device, to the external display device, via the communication circuitry.

According to an embodiment, the second execution history screen may include a visual object for generating a workspace. The instructions, when executed by the at least one processor individually or collectively, may cause the electronic device to, while the second execution history screen is displayed in the external display device, identify a fourth user input for the visual object included in the second execution history screen. The instructions, when executed by the at least one processor individually or collectively, may cause the electronic device to, based on the fourth user input for the visual object, generate a third workspace. The instructions, when executed by the at least one processor individually or collectively, may cause the electronic device to, based on the fourth user input for the visual object, identify the third workspace as a workspace to be provided in the external display device. The instructions, when executed by the at least one processor individually or collectively, may cause the electronic device to, based on the fourth user input for the visual object, transmit data for displaying the third workspace in the external display device, to the external display device, via the communication circuitry.

According to an embodiment, the second execution history screen may include at least one of at least a portion of the first UI object corresponding to the first workspace or at least a portion of the second UI object corresponding to the second workspace. The instructions, when executed by the at least one processor individually or collectively, may cause the electronic device to, while the second execution history screen is displayed in the external display device, identify a fourth user input for the at least a portion of the first UI object included in the second execution history screen. The instructions, when executed by the at least one processor individually or collectively, may cause the electronic device to, based on the fourth user input for the at least a portion of the first UI object, change a workspace to be displayed via the display from the first workspace to the second workspace. The instructions, when executed by the at least one processor individually or collectively, may cause the electronic device to, based on the fourth user input for the at least a portion of the first UI object, display the second workspace via the display. The instructions, when executed by the at least one processor individually or collectively, may cause the electronic device to, based on the fourth user input for the at least a portion of the first UI object, change data to be transmitted to the external display device via the communication circuitry from the data for displaying the second workspace in the external display device to data for displaying the first workspace in the external display device.

According to an embodiment, the instructions, when executed by the at least one processor individually or collectively, may cause the electronic device to, based on transmitting the data for displaying the second workspace in the external display device, store information for the second workspace in conjunction with information for the external display device. The instructions, when executed by the at least one processor individually or collectively, may cause the electronic device to identify a release of the connection between the electronic device and the external display device while the second workspace is displayed in the external display device. The instructions, when executed by the at least one processor individually or collectively, may cause the electronic device to, after identifying the release of the connection, identify again, the external display device connected to the electronic device via the communication circuitry. The instructions, when executed by the at least one processor individually or collectively, may cause the electronic device to, based on identifying again the external display device, in accordance with the information for the second workspace and the information for the external display device, transmit data for displaying the second workspace in the external display device, to the external display device, via the communication circuitry.

According to an embodiment, the communication circuitry may include first communication circuitry configured to support wireless communication or second communication circuitry configured to support wired communication.

As described above, a method performed in an electronic device having a display and communication circuitry may include generating a first workspace and a second workspace each configured to display an execution screen in a window having window control buttons. The method may include displaying, via the display, the first workspace from among the first workspace and the second workspace. The method may include identifying an external display device connected to the electronic device, via the communication circuitry. The method may include, based on identifying the external display device being connected to the electronic device while the first workspace is displayed, identifying the second workspace not displayed via the display as a workspace to be provided in the external display device. The method may include transmitting data for displaying the second workspace in the external display device, to the external display device, via the communication circuitry. The method may include, based on a first user input being received while the first workspace is displayed via the display of the electronic device and the second workspace is displayed in the external display device, displaying, via the display, an execution history screen including at least one of at least a portion of a first user interface (UI) object corresponding to the first workspace or at least a portion of a second UI object corresponding to the second workspace. The method may include, while the execution history screen is displayed via the display, identifying a second user input for the at least a portion of the second UI object corresponding to the second workspace. The method may include, based on the second user input, changing a workspace to be provided in the external display device from the second workspace to the first workspace. The method may include, based on the second user input, transmitting data for displaying the first workspace in the external display device, to the external display device, via the communication circuitry. The method may include, based on the second user input, displaying, via the display, the second workspace.

According to an embodiment, the execution history screen may include a visual object for generating a workspace. The method may include, while the execution history screen is displayed via the display, identifying a third user input for the visual object included in the execution history screen. The method may include, based on the third user input for the visual object, generating a third workspace. The method may include, based on the third user input for the visual object, displaying, via the display, the third workspace from among the first workspace, the second workspace, and the third workspace.

According to an embodiment, the method may include, based on the third user input for the visual object, maintaining transmitting the data for displaying the second workspace in the external display device, to the external display device, via the communication circuitry.

According to an embodiment, the method may include, based on the first user input, maintaining transmitting the data for displaying the second workspace in the external display device, to the external display device, via the communication circuitry.

According to an embodiment, the first user input may include an input for a first visual object for displaying the first execution history screen included in the first workspace or an input for a contact point identified as being positioned within the first workspace.

According to an embodiment, the execution history screen may be a first execution history screen. The first user input may be a user input for displaying the first execution history screen via the display. The method may include, while the first workspace is displayed via the display of the electronic device and the second workspace is displayed in the external display device, identifying a third user input for displaying a second execution history screen corresponding to the first execution history screen in the external display device. The method may include, based on the third user input, maintaining displaying the first workspace via the display. The method may include, based on the third user input, transmitting data for displaying the second workspace in the external display device, to the external display device, via the communication circuitry.

According to an embodiment, the second execution history screen may include a visual object for generating a workspace. The method may include, while the second execution history screen is displayed in the external display device, identifying a fourth user input for the visual object included in the second execution history screen. The method may include, based on the fourth user input for the visual object, generating a third workspace. The method may include, based on the fourth user input for the visual object, identifying the third workspace as a workspace to be provided in the external display device. The method may include, based on the fourth user input for the visual object, transmitting data for displaying the third workspace in the external display device, to the external display device, via the communication circuitry.

According to an embodiment, the second execution history screen may include at least one of at least a portion of the first UI object corresponding to the first workspace or at least a portion of the second UI object corresponding to the second workspace. The method may include, while the second execution history screen is displayed in the external display device, identifying a fourth user input for the at least a portion of the first UI object included in the second execution history screen. The method may include, based on the fourth user input for the at least a portion of the first UI object, changing a workspace to be displayed via the display from the first workspace to the second workspace. The method may include, based on the fourth user input for the at least a portion of the first UI object, displaying the second workspace via the display. The method may include, based on the fourth user input for the at least a portion of the first UI object, changing data to be transmitted to the external display device via the communication circuitry from the data for displaying the second workspace in the external display device to data for displaying the first workspace in the external display device.

According to an embodiment, the method may include, based on transmitting the data for displaying the second workspace in the external display device, storing information for the second workspace in conjunction with information for the external display device. The method may include identifying a release of the connection between the electronic device and the external display device while the second workspace is displayed in the external display device. The method may include, after identifying the release of the connection, identifying again, the external display device connected to the electronic device via the communication circuitry. The method may include, based on identifying again the external display device, in accordance with the information for the second workspace and the information for the external display device, transmitting data for displaying the second workspace in the external display device, to the external display device, via the communication circuitry.

According to an embodiment, the communication circuitry may include first communication circuitry configured to support wireless communication or second communication circuitry configured to support wired communication.

As described above, in a non-transitory computer readable storage medium in which one or more programs are stored, the one or more programs, when executed by an electronic device having a display and communication circuitry, may include instructions that cause the electronic device to generate a first workspace and a second workspace each configured to display an execution screen in a window having window control buttons. The one or more programs, when executed by the electronic device, may include instructions that cause the electronic device to display, via the display, a first workspace from among the first workspace and the second workspace. The one or more programs, when executed by the electronic device, may include instructions that cause the electronic device to identify an external display device connected to the electronic device, via the communication circuitry. The one or more programs, when executed by the electronic device, may include instructions that cause the electronic device to, based on identifying the external display device being connected to the electronic device while the first workspace is displayed, identify the second workspace not displayed via the display as a workspace to be provided in the external display device. The one or more programs, when executed by the electronic device, may include instructions that cause the electronic device to transmit data for displaying the second workspace in the external display device, to the external display device, via the communication circuitry. The one or more programs, when executed by the electronic device, may include instructions that cause the electronic device to, based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace. The one or more programs, when executed by the electronic device, may include instructions that cause the electronic device to, while the execution history screen is displayed via the display, identify a second user input for the at least a portion of the second UI object corresponding to the second workspace. The one or more programs, when executed by the electronic device, may include instructions that cause the electronic device to, based on the second user input, change a workspace to be provided in the external display device from the second workspace to the first workspace. The one or more programs, when executed by the electronic device, may include instructions that cause the electronic device to, based on the second user input, transmit data for displaying the first workspace in the external display device, to the external display device, via the communication circuitry. The one or more programs, when executed by the electronic device, may include instructions that cause the electronic device to, based on the second user input, display, via the display, the second workspace.

According to an embodiment, the execution history screen may include a visual object for generating a workspace. The one or more programs, when executed by the electronic device, may include instructions that cause the electronic device to, while the execution history screen is displayed via the display, identify a third user input for the visual object included in the execution history screen. The one or more programs, when executed by the electronic device, may include instructions that cause the electronic device to, based on the third user input for the visual object, generate a third workspace. The one or more programs, when executed by the electronic device, may include instructions that cause the electronic device to, based on the third user input for the visual object, display, via the display, the third workspace from among the first workspace, the second workspace, and the third workspace.

According to an embodiment, the one or more programs, when executed by the electronic device, may include instructions that cause the electronic device to, based on the third user input for the visual object, maintain an operation of transmitting the data for displaying the second workspace in the external display device, to the external display device, via the communication circuitry.

According to an embodiment, the one or more programs, when executed by the electronic device, may include instructions that cause the electronic device to, based on the first user input, maintain an operation of transmitting the data for displaying the second workspace in the external display device, to the external display device, via the communication circuitry.

According to an embodiment, the first user input may include an input for a first visual object for displaying the first execution history screen included in the first workspace or an input for a contact point identified as being positioned within the first workspace.

According to an embodiment, the execution history screen may be a first execution history screen. The first user input may be a user input for displaying the first execution history screen via the display. The one or more programs, when executed by the electronic device, may include instructions that cause the electronic device to, while the first workspace is displayed via the display of the electronic device and the second workspace is displayed in the external display device, identify a third user input for displaying a second execution history screen corresponding to the first execution history screen in the external display device.

The one or more programs, when executed by the electronic device, may include instructions that cause the electronic device to, based on the third user input, maintain an operation of displaying the first workspace via the display. The one or more programs, when executed by the electronic device, may include instructions that cause the electronic device to, based on the third user input, transmit data for displaying the second workspace in the external display device, to the external display device, via the communication circuitry. According to an embodiment, the second execution history screen may include a visual object for generating a workspace. The one or more programs, when executed by the electronic device, may include instructions that cause the electronic device to, while the second execution history screen is displayed in the external display device, identify a fourth user input for the visual object included in the second execution history screen. The one or more programs, when executed by the electronic device, may include instructions that cause the electronic device to, based on the fourth user input for the visual object, generate a third workspace. The one or more programs, when executed by the electronic device, may include instructions that cause the electronic device to, based on the fourth user input for the visual object, identify the third workspace as a workspace to be provided in the external display device. The one or more programs, when executed by the electronic device, may include instructions that cause the electronic device to, based on the fourth user input for the visual object, transmit data for displaying the third workspace in the external display device, to the external display device, via the communication circuitry.

According to an embodiment, the second execution history screen may include at least one of at least a portion of the first UI object corresponding to the first workspace or at least a portion of the second UI object corresponding to the second workspace. The one or more programs, when executed by the electronic device, may include instructions that cause the electronic device to, while the second execution history screen is displayed in the external display device, identify a fourth user input for the at least a portion of the first UI object included in the second execution history screen. The one or more programs, when executed by the electronic device, may include instructions that cause the electronic device to, based on the fourth user input for the at least a portion of the first UI object, change a workspace to be displayed via the display from the first workspace to the second workspace. The one or more programs, when executed by the electronic device, may include instructions that cause the electronic device to, based on the fourth user input for the at least a portion of the first UI object, display the second workspace via the display. The one or more programs, when executed by the electronic device, may include instructions that cause the electronic device to, based on the fourth user input for the at least a portion of the first UI object, change data to be transmitted to the external display device via the communication circuitry from the data for displaying the second workspace in the external display device to data for displaying the first workspace in the external display device.

According to an embodiment, the one or more programs, when executed by the electronic device, may include instructions that cause the electronic device to, based on transmitting the data for displaying the second workspace in the external display device, store information for the second workspace in conjunction with information for the external display device. The one or more programs, when executed by the electronic device, may include instructions that cause the electronic device to, identify a release of the connection between the electronic device and the external display device while the second workspace is displayed in the external display device. The one or more programs, when executed by the electronic device, may include instructions that cause the electronic device to, after identifying the release of the connection, identify again, the external display device connected to the electronic device via the communication circuitry. The one or more programs, when executed by the electronic device, may include instructions that cause the electronic device to, based on identifying again the external display device, in accordance with the information for the second workspace and the information for the external display device, transmit data for displaying the second workspace in the external display device, to the external display device, via the communication circuitry.

According to an embodiment, the communication circuitry may include first communication circuitry configured to support wireless communication or second communication circuitry configured to support wired communication.

As described above, an electronic device may include a display. The electronic device may include communication circuitry. The electronic device may include memory including one or more storage media storing instructions. The electronic device may include at least one processor including processing circuitry. The instructions, when executed by the at least one processor individually or collectively, may cause the electronic device to generate a first workspace and a second workspace each configured to display an execution screen in a window having window control buttons. The instructions, when executed by the at least one processor individually or collectively, may cause the electronic device to display, via the display, the first workspace from among the first workspace and the second workspace. The instructions, when executed by the at least one processor individually or collectively, may cause the electronic device to identify an external display device connected to the electronic device, via the communication circuitry. The instructions, when executed by the at least one processor individually or collectively, may cause the electronic device to, based on identifying the external display device being connected to the electronic device while the first workspace is displayed, identify the second workspace not displayed via the display as a workspace to be provided in the external display device. The instructions, when executed by the at least one processor individually or collectively, may cause the electronic device to transmit data for displaying the second workspace in the external display device, to the external display device, via the communication circuitry. The instructions, when executed by the at least one processor individually or collectively, may cause the electronic device to, while the first workspace is displayed via the display of the electronic device and the second workspace is displayed in the external display device, allow moving a pointer between the first workspace and the second workspace. The instructions, when executed by the at least one processor individually or collectively, may cause the electronic device to, while the first workspace is displayed via the display of the electronic device and the second workspace is displayed in the external display device, disallow moving a window movable in the first workspace into the second workspace. The instructions, when executed by the at least one processor individually or collectively, may cause the electronic device to, while the first workspace is displayed via the display of the electronic device and the second workspace is displayed in the external display device, disallow moving a window movable in the second workspace into the first workspace.

According to an embodiment, the instructions, when executed by the at least one processor individually or collectively, may cause the electronic device to identify a user input for an application object included in the first workspace displayed via the display, using the pointer. The instructions, when executed by the at least one processor individually or collectively, may cause the electronic device to, based on the user input, display, within the first workspace, a window including both an execution screen corresponding to the application object and window control buttons.

According to an embodiment, the instructions, when executed by the at least one processor individually or collectively, may cause the electronic device to identify a user input for an application object included in the second workspace displayed in the external display device, using the pointer. The instructions, when executed by the at least one processor individually or collectively, may cause the electronic device to, based on the user input, transmit data for displaying, within the second workspace, a window including both an execution screen corresponding to the application object and window control buttons.

According to an embodiment, the instructions, when executed by the at least one processor individually or collectively, may cause the electronic device to identify, a user input for displaying an execution history screen. The instructions, when executed by the at least one processor individually or collectively, may cause the electronic device to, based on identifying that the user input is associated with the first workspace from among the first workspace and the second workspace, display, via the display, a first execution history screen including at least one of at least a portion of a first UI object corresponding to the first workspace or at least a portion of a second UI object corresponding to the second workspace. The instructions, when executed by the at least one processor individually or collectively, may cause the electronic device to, based on identifying that the user input is associated with the second workspace from among the first workspace and the second workspace, transmit data for displaying a second execution history screen including at least one of at least a portion of the first UI object corresponding to the first workspace or at least a portion of the second UI object corresponding to the second workspace in the external display device, to the external display device, via the communication circuitry.

According to an embodiment, the first execution history screen may include a visual object for generating a workspace. The instructions, when executed by the at least one processor individually or collectively, may cause the electronic device to, while the first execution history screen is displayed via the display, identify a user input for the visual object included in the first execution history screen. The instructions, when executed by the at least one processor individually or collectively, may cause the electronic device to, based on the user input for the visual object, generate a third workspace. The instructions, when executed by the at least one processor individually or collectively, may cause the electronic device to, based on the user input for the visual object, display, via the display, the third workspace from among the first workspace, the second workspace, and the third workspace.

According to an embodiment, the window control buttons may include a button for minimizing a window size, a button for maximizing a window size, and a window exit button.

According to an embodiment, the communication circuitry may include first communication circuitry configured to support wireless communication or second communication circuitry configured to support wired communication.

As described above, a method performed in an electronic device having a display and communication circuitry may include generating a first workspace and a second workspace each configured to display an execution screen in a window having window control buttons. The method may include displaying, via the display, the first workspace from among the first workspace and the second workspace each configured to display an execution screen in a window having window control buttons. The method may include identifying an external display device connected to the electronic device, via the communication circuitry. The method may include, based on identifying the external display device being connected to the electronic device while the first workspace is displayed, identifying the second workspace not displayed via the display as a workspace to be provided in the external display device. The method may include transmitting data for displaying the second workspace in the external display device, to the external display device, via the communication circuitry. The method may include, while the first workspace is displayed via the display of the electronic device and the second workspace is displayed in the external display device, allowing moving a pointer between the first workspace and the second workspace. The method may include, while the first workspace is displayed via the display of the electronic device and the second workspace is displayed in the external display device, disallowing moving a window movable in the first workspace into the second workspace. The method may include, while the first workspace is displayed via the display of the electronic device and the second workspace is displayed in the external display device, disallowing moving a window movable in the second workspace into the first workspace.

According to an embodiment, the method may include identifying a user input for an application object included in the first workspace displayed via the display, using the pointer. The method may include, based on the user input, displaying, within the first workspace, a window including both an execution screen corresponding to the application object and window control buttons.

According to an embodiment, the method may include identifying a user input for an application object included in the second workspace displayed in the external display device, using the pointer. The method may include, based on the user input, transmitting data for displaying, within the second workspace, a window including both an execution screen corresponding to the application object and window control buttons.

According to an embodiment, the method may include identifying, a user input for displaying an execution history screen. The method may include, based on identifying that the user input is associated with the first workspace from among the first workspace and the second workspace, displaying, via the display, a first execution history screen including at least one of at least a portion of a first UI object corresponding to the first workspace or at least a portion of a second UI object corresponding to the second workspace. The method may include, based on identifying that the user input is associated with the second workspace from among the first workspace and the second workspace, transmitting data for displaying a second execution history screen including at least one of at least a portion of the first UI object corresponding to the first workspace or at least a portion of the second UI object corresponding to the second workspace in the external display device, to the external display device, via the communication circuitry.

According to an embodiment, the first execution history screen may include a visual object for generating a workspace. The method may include, while the first execution history screen is displayed via the display, identifying a user input for the visual object included in the first execution history screen. The method may include, based on the user input for the visual object, generating a third workspace. The method may include, based on the user input for the visual object, displaying, via the display, the third workspace from among the first workspace, the second workspace, and the third workspace.

According to an embodiment, the window control buttons may include a button for minimizing a window size, a button for maximizing a window size, and a window exit button.

According to an embodiment, the communication circuitry may include first communication circuitry configured to support wireless communication or second communication circuitry configured to support wired communication.

As described above, in a non-transitory computer readable storage medium in which one or more programs are stored, the one or more programs, when executed by an electronic device having a display and communication circuitry, may include instructions that cause the electronic device to generate a first workspace and a second workspace each configured to display an execution screen in a window having window control buttons. The one or more programs, when executed by the electronic device, may include instructions that cause the electronic device to display, via the display, the first workspace from among the first workspace and the second workspace. The one or more programs, when executed by the electronic device, may include instructions that cause the electronic device to identify an external display device connected to the electronic device, via the communication circuitry. The one or more programs, when executed by the electronic device, may include instructions that cause the electronic device to, based on identifying the external display device being connected to the electronic device while the first workspace is displayed, identify that the second workspace is not displayed via the display as a workspace to be provided in the external display device. The one or more programs, when executed by the electronic device, may include instructions that cause the electronic device to transmit data for displaying the second workspace in the external display device, to the external display device, via the communication circuitry. The one or more programs, when executed by the electronic device, may include instructions that cause the electronic device to, while the first workspace is displayed via the display of the electronic device and the second workspace is displayed in the external display device, allow moving a pointer between the first workspace and the second workspace. The one or more programs, when executed by the electronic device, may include instructions that cause the electronic device to, while the first workspace is displayed via the display of the electronic device and the second workspace is displayed in the external display device, disallow moving a window movable in the first workspace into the second workspace. The one or more programs, when executed by the electronic device, may include instructions that cause the electronic device to, while the first workspace is displayed via the display of the electronic device and the second workspace is displayed in the external display device, disallow moving a window movable in the second workspace into the first workspace.

According to an embodiment, the one or more programs, when executed by the electronic device, may include instructions that cause the electronic device to identify a user input for an application object included in the first workspace displayed via the display, using the pointer. The one or more programs, when executed by the electronic device, may include instructions that cause the electronic device to, based on the user input, display, within the first workspace, a window including both an execution screen corresponding to the application object and window control buttons.

According to an embodiment, the one or more programs, when executed by the electronic device, may include instructions that cause the electronic device to identify a user input for an application object included in the second workspace displayed in the external display device, using the pointer. The one or more programs, when executed by the electronic device, may include instructions that cause the electronic device to, based on the user input, transmit data for displaying, within the second workspace, a window including both an execution screen corresponding to the application object and window control buttons.

According to an embodiment, the one or more programs, when executed by the electronic device, may include instructions that cause the electronic device to identify, a user input for displaying an execution history screen. The one or more programs, when executed by the electronic device, may include instructions that cause the electronic device to, based on identifying that the user input is associated with the first workspace from among the first workspace and the second workspace, display, via the display, a first execution history screen including at least one of at least a portion of a first UI object corresponding to the first workspace or at least a portion of a second UI object corresponding to the second workspace. The one or more programs, when executed by the electronic device, may include instructions that cause the electronic device to, based on identifying that the user input is associated with the second workspace from among the first workspace and the second workspace, transmit data for displaying a second execution history screen including at least one of at least a portion of the first UI object corresponding to the first workspace or at least a portion of the second UI object corresponding to the second workspace in the external display device, to the external display device, via the communication circuitry.

According to an embodiment, the first execution history screen may include a visual object for generating a workspace. The one or more programs, when executed by the electronic device, may include instructions that cause the electronic device to, while the first execution history screen is displayed via the display, identify a user input for the visual object included in the first execution history screen. The one or more programs, when executed by the electronic device, may include instructions that cause the electronic device to, based on the user input for the visual object, generate a third workspace. The one or more programs, when executed by the electronic device, may include instructions that cause the electronic device to, based on the user input for the visual object, display, via the display, the third workspace from among the first workspace, the second workspace, and the third workspace.

According to an embodiment, the window control buttons may include a button for minimizing a window size, a button for maximizing a window size, and a window exit button.

According to an embodiment, the communication circuitry may include first communication circuitry configured to support wireless communication or second communication circuitry configured to support wired communication.

As described above, an electronic device may include a display. The electronic device may include communication circuitry. The electronic device may include memory including one or more storage media storing instructions. The electronic device may include at least one processor including processing circuitry. The instructions, when executed by the at least one processor individually or collectively, cause the electronic device to display, via the display, a first workspace configured to display an execution screen in a window having window control buttons. The instructions, when executed by the at least one processor individually or collectively, cause the electronic device to, while displaying the first workspace, identify an external display device connected to the electronic device, via the communication circuitry. The instructions, when executed by the at least one processor individually or collectively, cause the electronic device to, based on identifying the external display device, generate a second workspace configured to display an execution screen in a window having window control buttons. The instructions, when executed by the at least one processor individually or collectively, cause the electronic device to transmit data for displaying the second workspace in the external display device, to the external display device, via the communication circuitry. The instructions, when executed by the at least one processor individually or collectively, cause the electronic device to, based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace. The instructions, when executed by the at least one processor individually or collectively, cause the electronic device to, while the execution history screen is displayed via the display, identify a second user input for the at least a portion of the second UI object corresponding to the second workspace. The instructions, when executed by the at least one processor individually or collectively, cause the electronic device to, based on the second user input, change a workspace to be provided in the external display device from the second workspace to the first workspace. The instructions, when executed by the at least one processor individually or collectively, cause the electronic device to, based on the second user input, transmit data for displaying the first workspace in the external display device, to the external display device, via the communication circuitry. The instructions, when executed by the at least one processor individually or collectively, cause the electronic device to, based on the second user input, display, via the display, the second workspace.

According to an embodiment, the execution history screen may include a visual object for generating a workspace. The instructions, when executed by the at least one processor individually or collectively, may cause the electronic device to, while the execution history screen is displayed via the display, identify a third user input for the visual object included in the execution history screen. The instructions, when executed by the at least one processor individually or collectively, may cause the electronic device to, based on the third user input for the visual object, generate a third workspace. The instructions, when executed by the at least one processor individually or collectively, may cause the electronic device to, based on the third user input for the visual object, display, via the display, the third workspace from among the first workspace, the second workspace, and the third workspace.

According to an embodiment, the instructions, when executed by the at least one processor individually or collectively, may cause the electronic device to, based on the third user input for the visual object, maintain an operation of transmitting the data for displaying the second workspace in the external display device, to the external display device, via the communication circuitry.

As described above, a method performed in an electronic device having a display and communication circuitry may include displaying, via the display, a first workspace configured to display an execution screen in a window having window control buttons. The method may include identifying an external display device connected to the electronic device, via the communication circuitry. The method may include, based on identifying the external display device, generating a second workspace configured to display an execution screen in a window having window control buttons. The method may include transmitting data for displaying the second workspace in the external display device, to the external display device, via the communication circuitry. The method may include, based on a first user input being received while the first workspace is displayed via the display of the electronic device and the second workspace is displayed in the external display device, displaying, via the display, an execution history screen including at least one of at least a portion of a first user interface (UI) object corresponding to the first workspace or at least a portion of a second UI object corresponding to the second workspace. The method may include, while the execution history screen is displayed via the display, identifying a second user input for the at least a portion of the second UI object corresponding to the second workspace. The method may include, based on the second user input, changing a workspace to be provided in the external display device from the second workspace to the first workspace. The method may include, based on the second user input, transmitting data for displaying the first workspace in the external display device, to the external display device, via the communication circuitry. The method may include, based on the second user input, displaying, via the display, the second workspace.

According to an embodiment, the execution history screen may include a visual object for generating a workspace. The method may include, while the execution history screen is displayed via the display, identifying a third user input for the visual object included in the execution history screen. The method may include, based on the third user input for the visual object, generating a third workspace. The method may include, based on the third user input for the visual object, displaying, via the display, the third workspace from among the first workspace, the second workspace, and the third workspace.

According to an embodiment, the method may include, based on the third user input for the visual object, maintaining transmitting the data for displaying the second workspace in the external display device, to the external display device, via the communication circuitry.

As described above, in a non-transitory computer readable storage medium in which one or more programs are stored, the one or more programs, when executed by an electronic device having a display and communication circuitry, may include instructions that cause the electronic device to display, via the display, a first workspace configured to display an execution screen in a window having window control buttons. The one or more programs, when executed by the electronic device, may include instructions that cause the electronic device to identify an external display device connected to the electronic device, via the communication circuitry. The one or more programs, when executed by the electronic device, may include instructions that cause the electronic device to, based on identifying the external display device, generate a second workspace configured to display an execution screen in a window having window control buttons. The one or more programs, when executed by the electronic device, may include instructions that cause the electronic device to transmit data for displaying the second workspace in the external display device, to the external display device, via the communication circuitry. The one or more programs, when executed by the electronic device, may include instructions that cause the electronic device to, based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace. The one or more programs, when executed by the electronic device, may include instructions that cause the electronic device to, while the execution history screen is displayed via the display, identify a second user input for the at least a portion of the second UI object corresponding to the second workspace. The one or more programs, when executed by the electronic device, may include instructions that cause the electronic device to, based on the second user input, change a workspace to be provided in the external display device from the second workspace to the first workspace. The one or more programs, when executed by the electronic device, may include instructions that cause the electronic device to, based on the second user input, transmit data for displaying the first workspace in the external display device, to the external display device, via the communication circuitry. The one or more programs, when executed by the electronic device, may include instructions that cause the electronic device to, based on the second user input, display, via the display, the second workspace.

According to an embodiment, the execution history screen may include a visual object for generating a workspace. The one or more programs, when executed by the electronic device, may include instructions that cause the electronic device to, while the execution history screen is displayed via the display, identify a third user input for the visual object included in the execution history screen. The one or more programs, when executed by the electronic device, may include instructions that cause the electronic device to, based on the third user input for the visual object, generate a third workspace. The one or more programs, when executed by the electronic device, may include instructions that cause the electronic device to, based on the third user input for the visual object, display, via the display, the third workspace from among the first workspace, the second workspace, and the third workspace.

According to an embodiment, the one or more programs, when executed by the electronic device, may include instructions that cause the electronic device to, based on the third user input for the visual object, maintain an operation of transmitting the data for displaying the second workspace in the external display device, to the external display device, via the communication circuitry.

For one or more embodiments, at least one of components described in one or more preceding drawings may be configured to perform one or more operations, techniques, processes, and/or methods as described in the present disclosure. As an example, a processor (e.g., a baseband processor) described in the present disclosure in connection with one or more preceding drawings may be configured to operate according to one or more examples described in the present disclosure. As another example, circuitry associated with a user equipment (UE), a base station, a network element, and the like, as described above in connection with one or more preceding drawings, may be configured to operate according to one or more examples described herein.

Any of the embodiments described above may be combined with any other embodiment (or a combination of embodiments), unless expressly stated otherwise. The above-described description regarding one or more implementations provides an example and a description, but is not intended to be exhaustive or to limit the scope of the embodiments to the precise forms disclosed. Modification and variation may be possible, or may be obtained from practicing various embodiments, in light of the above teachings.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., through at least one wire), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701). For example, a processor (e.g., the processor 1720) of the machine (e.g., the electronic device 1701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

No claim element is to be construed under the provisions of 35 U.S.C. § 112, sixth paragraph, unless the element is expressly recited using the phrase “means for“ or ”means”.

What is claimed is:

1. An electronic device comprising:
a display;
communication circuitry;
at least one processor comprising processing circuitry; and
memory comprising one or more storage media storing instructions that, when executed by the at least one processor individually or collectively, cause the electronic device to:
generate a first workspace and a second workspace each configured to display an execution screen in a window having window control buttons,
display, via the display, the first workspace from among the first workspace and the second workspace,
identify an external display device connected to the electronic device, via the communication circuitry,
based on identifying the external display device being connected to the electronic device while the first workspace is displayed, identify the second workspace not displayed via the display as a workspace to be provided in the external display device,
transmit, to the external display device, via the communication circuitry, data for displaying the second workspace in the external display device,
based on a first user input being received while the first workspace is displayed via the display of the electronic device and the second workspace is displayed in the external display device, display, via the display, an execution history screen including at least one of at least a portion of a first user interface (UI) object corresponding to the first workspace or at least a portion of a second UI object corresponding to the second workspace,
while the execution history screen is displayed via the display, identify a second user input for the at least a portion of the second UI object corresponding to the second workspace, and
based on the second user input:
change a workspace to be provided in the external display device from the second workspace to the first workspace,
transmit data for displaying the first workspace in the external display device, to the external display device, via the communication circuitry, and
display, via the display, the second workspace.

2. The electronic device of claim 1, wherein the execution history screen comprises a visual object for generating a workspace, and
wherein the instructions, when executed by the at least one processor individually or collectively, cause the electronic device to:
while the execution history screen is displayed via the display, identify a third user input for the visual object of the execution history screen, and
based on the third user input for the visual object of the execution history screen:
generate a third workspace, and
display, via the display, the third workspace from among the first workspace, the second workspace, and the third workspace.

3. The electronic device of claim 2, wherein the instructions, when executed by the at least one processor individually or collectively, cause the electronic device to, based on the third user input for the visual object, maintain an operation of transmitting the data for displaying the second workspace in the external display device, to the external display device, via the communication circuitry.

4. The electronic device of claim 1, wherein the instructions, when executed by the at least one processor individually or collectively, cause the electronic device to, based on the first user input, maintain an operation of transmitting the data for displaying the second workspace in the external display device, to the external display device, via the communication circuitry.

5. The electronic device of claim 1, wherein the first user input comprises an input for a first visual object for displaying the first execution history screen or an input for a contact point identified as being positioned within the first workspace,
wherein the first object is included in the first workspace.

6. The electronic device of claim 1, wherein the execution history screen is a first execution history screen,
wherein the first user input is a user input for displaying the first execution history screen via the display, and
wherein the instructions, when executed by the at least one processor individually or collectively, cause the electronic device to:
while the first workspace is displayed via the display of the electronic device and the second workspace is displayed in the external display device, identify a third user input for displaying a second execution history screen corresponding to the first execution history screen in the external display device, and
based on the third user input:
maintain an operation of displaying the first workspace via the display, and
transmit data for displaying the second workspace in the external display device, to the external display device, via the communication circuitry.

7. The electronic device of claim 6, wherein the second execution history screen comprises a visual object for generating a workspace, and
wherein the instructions, when executed by the at least one processor individually or collectively, cause the electronic device to:
while the second execution history screen is displayed in the external display device, identify a fourth user input for the visual object in the second execution history screen, and
based on the fourth user input for the visual object:
generate a third workspace,
identify the third workspace as a workspace to be provided in the external display device, and
transmit data for displaying the third workspace in the external display device, to the external display device, via the communication circuitry.

8. The electronic device of claim 6, wherein the second execution history screen comprises at least one of at least a portion of the first UI object corresponding to the first workspace or at least a portion of the second UI object corresponding to the second workspace, and
wherein the instructions, when executed by the at least one processor individually or collectively, cause the electronic device to:
while the second execution history screen is displayed in the external display device, identify a fourth user input for the at least a portion of the first UI object in the second execution history screen, and
based on the fourth user input for the at least a portion of the first UI object:
change a workspace to be displayed via the display from the first workspace to the second workspace,
display the second workspace via the display, and
change data to be transmitted to the external display device via the communication circuitry from the data for displaying the second workspace in the external display device to data for displaying the first workspace in the external display device.

9. The electronic device of claim 1, wherein the instructions, when executed by the at least one processor individually or collectively, cause the electronic device to:
based on transmitting the data for displaying the second workspace in the external display device, store information for the second workspace in conjunction with information for the external display device,
identify a release of the connection between the electronic device and the external display device while the second workspace is displayed in the external display device,
after identifying the release of the connection between the electronic device and the external display device, identify a second connection between the external display device and the electronic device via the communication circuitry, and
based on the second connection between the electronic device and the external display device, in accordance with the information for the second workspace and the information for the external display device, transmit data for displaying the second workspace in the external display device, to the external display device, via the communication circuitry.

10. The electronic device of claim 1, wherein the communication circuitry comprises at least one of first communication circuitry configured to support wireless communication or second communication circuitry configured to support wired communication.

11. An electronic device comprising:
a display;
communication circuitry;
at least one processor comprising processing circuitry; and
memory comprising one or more storage media storing instructions that, when executed by the at least one processor individually or collectively, cause the electronic device to:
generate a first workspace and a second workspace each configured to display an execution screen in a window having window control buttons;
display, via the display, the first workspace from among the first workspace and the second workspace,
identify an external display device connected to the electronic device, via the communication circuitry,
based on identifying the external display device being connected to the electronic device while the first workspace is displayed, identify the second workspace not displayed via the display as a workspace to be provided in the external display device,
transmit data for displaying the second workspace in the external display device, to the external display device, via the communication circuitry, and
while the first workspace is displayed via the display of the electronic device and the second workspace is displayed in the external display device:
allow moving a pointer between the first workspace and the second workspace,
disallow moving a window movable in the first workspace into the second workspace, and
disallow moving a window movable in the second workspace into the first workspace.

12. The electronic device of claim 11, wherein the instructions, when executed by the at least one processor individually or collectively, cause the electronic device to:
identify a user input for an application object in the first workspace displayed via the display, using the pointer, and
based on the user input, display, within the first workspace, a window comprising an execution screen corresponding to the application object and window control buttons.

13. The electronic device of claim 11, wherein the instructions, when executed by the at least one processor individually or collectively, cause the electronic device to:
identify a user input for an application object in the second workspace displayed in the external display device, using the pointer, and
based on the user input, transmit data for displaying, within the second workspace, a window comprising an execution screen corresponding to the application object and window control buttons.

14. The electronic device of claim 11, wherein the instructions, when executed by the at least one processor individually or collectively, cause the electronic device to:
identify, a user input for displaying an execution history screen,
based on identifying that the user input is associated with the first workspace from among the first workspace and the second workspace, display, via the display, a first execution history screen comprising at least one of:
at least a portion of a first UI object corresponding to the first workspace, or
at least a portion of a second UI object corresponding to the second workspace, and
based on identifying that the user input is associated with the second workspace from among the first workspace and the second workspace, transmit data for displaying a second execution history screen comprising at least one of:
at least a portion of the first UI object corresponding to the first workspace, or
at least a portion of the second UI object corresponding to the second workspace in the external display device, to the external display device, via the communication circuitry.

15. The electronic device of claim 14, wherein the first execution history screen comprises a visual object for generating a workspace, and
wherein the instructions, when executed by the at least one processor individually or collectively, cause the electronic device to:
while the first execution history screen is displayed via the display, identify a user input for the visual object included in the first execution history screen, and
based on the user input for the visual object:
generate a third workspace, and
display, via the display, the third workspace from among the first workspace, the second workspace, and the third workspace.

16. The electronic device of claim 11, wherein the window control buttons comprises a button for minimizing a window size, a button for maximizing a window size, and a window exit button.

17. The electronic device of claim 11, wherein the communication circuitry comprises first communication circuitry configured to support wireless communication or second communication circuitry configured to support wired communication.

18. An electronic device comprising:
a display;
communication circuitry;
at least one processor comprising processing circuitry; and
memory comprising one or more storage media storing instructions that, when executed by the at least one processor individually or collectively, cause the electronic device to:
display, via the display, a first workspace configured to display an execution screen in a window having window control buttons,
while displaying the first workspace, identify an external display device connected to the electronic device, via the communication circuitry,
based on identifying the external display device, generate a second workspace configured to display an execution screen in a window having window control buttons,
transmit data for displaying the second workspace in the external display device, to the external display device, via the communication circuitry,
based on a first user input being received while the first workspace is displayed via the display of the electronic device and the second workspace is displayed in the external display device, display, via the display, an execution history screen comprising at least one of:
at least a portion of a first user interface (UI) object corresponding to the first workspace, or
at least a portion of a second UI object corresponding to the second workspace,
while the execution history screen is displayed via the display, identify a second user input for the at least a portion of the second UI object corresponding to the second workspace, and
based on the second user input:
change a workspace to be provided in the external display device from the second workspace to the first workspace,
transmit data for displaying the first workspace in the external display device, to the external display device, via the communication circuitry, and
display, via the display, the second workspace.

19. The electronic device of claim 18, wherein the execution history screen comprises a visual object for generating a workspace, and
wherein the instructions, when executed by the at least one processor individually or collectively, cause the electronic device to:
while the execution history screen is displayed via the display, identify a third user input for the visual object in the execution history screen, and
based on the third user input for the visual object:
generate a third workspace, and
display, via the display, the third workspace from among the first workspace, the second workspace, and the third workspace.

20. The electronic device of claim 19, wherein the instructions, when executed by the at least one processor individually or collectively, cause the electronic device to, based on the third user input for the visual object, maintain an operation of transmitting the data for displaying the second workspace in the external display device, to the external display device, via the communication circuitry.
